(19) United States
(12) Patent Application Publication
(10) Pub. No.: US 2008/0080703 A1
(43) Pub. Date: Apr. 3, 2008

(54) TELEPHONE STATION INCORPORATING WIRLESS HANDSET AND CRADLE FEATURE

(76) Inventors: Randall J. Penning, Middletown, NJ (US); Guido Nitsch, Wegberg (DE); Martin Daly, South Orange, NJ (US); Manfred Kling, Frankfurt am Main (DE)

Correspondence Address: MG-IP Law, PLLC, PO BOX 1364, FAIRFAX, VA, 22038-1364, US

(21) Appl. No.: 11/759,548

(22) Filed: Jun. 7, 2007

Related U.S. Application Data
(60) Provisional application No. 60/811,432, filed on Jun. 7, 2006.
(60) Provisional application No. 60/811,433, filed on Jun. 7, 2006.

(51) Int. Cl. H04M 1/00

(52) U.S. Cl. 379/428.02

(57) ABSTRACT

A modular system for supporting wireless and wired telecommunication includes a telephone base station having a housing configured to operatively connect with one or more modular adapters. The system includes a wireless adapter module configured to operatively connect to the telephone base station through the wireless adapter interface, and a wireless handset. The handset is configured to selectively communicate wirelessly with the telephone base station through an operative connection with the wireless adapter module and the wireless adapter module is configured to selectively communicate through a wired connection with the telephone base station. The wireless adapter module may be selectively paired with the handset or other local accessories, such as wired or wireless headsets.

### CROSS REFERENCE TO RELATED APPLICATIONS

This application claims priority to U.S. Provisional Application No. 60/811,432 entitled “TELEPHONE STATION INCORPORATING WIRELESS HANDSET AND CRADLE FEATURE” filed Jun. 7, 2006, and U.S. Provisional Application No. 60/811,433 entitled “TELEPHONE STATIONS WITH STATION INDEPENDENT BACKUP/RESTORE FEATURE” filed Jun. 7, 2006, each of which are assigned to the assignee hereof and hereby expressly incorporated by reference herein.

### BACKGROUND

This description generally relates to telecommunication stations having wireless accessories, and more particularly to telecommunication stations having wireless accessories with the dual functionality of wired and/or wireless communication with a telecommunication base station.

### DESCRIPTION OF THE BACKGROUND ART

Conventional desktop station telephones, such as deskphones and walk-up or lobby phones, often include displays which provide a plurality of different telephone functions or settings selectable by the user, e.g., Send All Calls, Priority, Call Forward, Directory, various display settings, default modes, and/or ring tones. In addition, the desktop station telephone typically includes a wired handset connected directly to the deskphone and may include optional accessory operation, e.g., through a wired headset connected directly to the desktop station telephone. Accordingly, when a user wishes to switch between operation of the phone in a wired mode to communicating in a mobile mode, the user will have to switch to a speakerphone mode for communications through the desktop station telephone and/or handoff or initiate calls to or from a separate mobile calling station, such as switching or forwarding an active or incoming call to a cellular phone.

### SUMMARY

In one general aspect, a modular system for supporting wireless and wired telecommunication includes a telephone base station having a housing configured to operatively connect with one or more modular adapters. The housing includes a display; an alphanumeric keypad; a wireless adapter interface; and a headset interface. The system includes a wireless adapter module and a wireless handset. The wireless adapter module is configured to operatively connect to the telephone base station through the wireless adapter interface. The wireless handset is configured to selectively communicate wirelessly with the telephone base station through an operative connection with the wireless adapter module. The wireless adapter module is configured to selectively communicate through a wired connection with the telephone base station.

Implementations of this aspect may include one or more of the following features. For example, the system may include a headset configured to communicate with the telephone base station through a wired connection with the headset interface. The wired connection with the headset interface may be operatively connected to the wireless adapter module. The system may include a second wired connection for operatively connecting the headset to the wireless adapter module. The headset may be configured to communicate wirelessly with the wireless adapter module or through a wired connection with the wireless adapter module. The wireless adapter module may include a controller configured to transmit and receive radio signals according to a frequency hopping radio system. The wireless adapter module may be configured to support communication with the wireless handset based on a radio-frequency standard, such as Bluetooth protocol.

The housing may include a first housing which includes the display and the alphanumeric keypad, and a second housing configured to operatively connect with the first housing. The second housing may include the headset interface, the wireless adapter interface, and a wireless handset cradle.

The system may include a third housing configured to operatively connect with the first housing instead of the second housing, wherein the third housing includes a handset cradle and a wired handset for operation of the system as a hard wired system. The handset cradle may include a recess contoured to integrally fit with an exterior surface of the wireless handset, and/or a power interface configured to operatively connect with a wireless handset when the wireless handset is positioned within the recess and to charge the wireless handset. The alphanumeric keypad may be an ISO (International Standards Organization) standard alphanumeric telephony keypad, such as for an IP enabled telephone.

In another general aspect, a wireless adapter module for supporting wireless and wired telecommunication includes a wireless adapter interface configured to operatively connect to a telephone base station and to support wireless communication with a wireless handset, and a headset interface configured to operatively connect to a headset to support communication with the telephone base station. The wireless adapter interface is configured to operatively connect to the telephone base station through a port within a host telephone base station.

Implementations of this aspect may include one or more of the following features. For example, the wireless adapter interface may be configured to operatively connect through a wireless connection with the telephone base station. The wireless adapter module may include a controller configured to transmit and receive radio signals with a wireless handset according to a frequency hopping radio system. The wireless adapter module may be configured to support communication with a wireless handset based on a radio-frequency standard. The radio-frequency standard may include BLUETOOTH protocol. The wireless adapter module may be a Bluetooth Class 2 device having a range of at least 10 meters, or more, such as up to 100 meters. The wireless adapter module may be configured to operatively connect to an adapter port of a Voice over Internet Protocol (VoIP) telephone base station. The wireless adapter module may be configured to operatively connect to an adapter port of the telephone base station, and the telephone base station is a Voice over Internet Protocol (VoIP) telephone base station.

In another general aspect, a method for managing a wireless accessory with a telephone base station includes detecting one or more wireless accessories paired with the telephone base station. The one or more wireless accessories paired with the telephone base station are identified and an operational state of any wired accessories and any of the wireless accessories paired with the telephone base station is determined. A first user interface is provided on a display of the telephone base station if a first wireless accessory is identified and determined to be in an active operational state which includes features for managing the first wireless accessory at the telephone base station. Alternatively, a second user interface is provided on the display of the telephone base station if an alternative accessory is identified and determined to be in an active operational state which includes features for managing the alternative accessory at the telephone base station.

Implementations of this aspect may include one or more of the following features. For example, the first wireless accessory may be a wireless headset or a wireless handset. The alternative accessory may be a wired accessory and/or a wireless accessory. The first wireless accessory and the alternative accessory comprise a wireless handset and a headset, respectively. The headset may be a wired or wireless headset. The wireless headset may be a Bluetooth device and the headset is a Bluetooth device. The wireless handset may be a Bluetooth device and the headset may be a wired headset. An operation of the first wireless accessory or the alternative accessory may be controlled with a softkey or button on the telephone base station.

In another general aspect, a computer-readable medium having computer-executable instructions contained therein for a method for managing a wireless accessory with a telephone base station, the method including detecting one or more wireless accessories paired with the telephone base station; identifying the one or more wireless accessories paired with the telephone base station; determining an operational state of any wired accessories and any of the wireless accessories paired with the telephone base station; providing a first user interface on a display of the telephone base station if a first wireless accessory is identified and determined to be in an active operational state which includes features for managing the first wireless accessory at the telephone base station; and alternatively providing a second user interface on the display of the telephone base station if an alternative accessory is identified and determined to be in an active operational state which includes features for managing the alternative accessory at the telephone base station.

In another general aspect, a modular system for supporting wireless and wired telecommunication includes a telephone base station having a housing configured to operatively connect with one or more modular adapters. The housing includes a display; an alphanumeric keypad; a wireless adapter interface; a headset interface; and a process controller. The system includes a wireless adapter module configured to operatively connect to the telephone base station through the wireless adapter interface. The system includes a wireless handset, wherein the handset is configured to selectively communicate wirelessly with the telephone base station through an operative connection with the wireless adapter module. The wireless adapter module is configured to selectively communicate through a wired connection with the telephone base station. The process controller may be configured to detect a power level of a wireless device in operative connection with the telephone base station, to detect and identify one or more wireless or wired accessories paired with the telephone base station, and to provide a unique user interface, associated with each identified wireless or wired accessory, to a user of the telephone base station.

In another general aspect, a method of managing a wireless accessory operatively connected to the telephone base station of one or more of the above-described systems includes receiving an indication of a power level of a wireless Bluetooth accessory paired with the telephone base station; and providing a user with a visual or audio signal from the telephone base station that the wireless Bluetooth accessory is in a low power state.

Implementations of this aspect may include one or more of the following features. For example, the user may be provided with a user interface on a display of the telephone base station which prompts a user to charge the wireless Bluetooth accessory on a charging cradle of the telephone base station.

In another general aspect, a method of managing a wireless handset associated with a IP telephone base station includes detecting an on-cradle or an off-cradle state for the wireless handset associated with the IP telephone base station. A voice data path is provided to the wireless handset if the wireless handset is in the off-cradle state. A voice date path is provided which omits the wireless handset if the wireless handset is in the on-cradle state.

Implementations of this aspect may include one or more of the following features. For example, an operational state of a headset associated with the IP telephone base station is detected; and alternatively, a voice date path may be provided to the headset associated with the IP telephone base station if the headset is in an active state. A first user interface may be provided on a display of the telephone base station if the wireless handset is detected in the off-cradle state, the user interface including features for managing the wireless handset at the telephone base station. If the headset is detected to be in an active operational state, a second user interface may be alternatively provided on the display of the telephone base station which includes features for managing the headset at the telephone base station. An indication of a power level of the wireless handset paired with the telephone base station may be received, such as at the telephone base station or a wireless adapter module, and a user may be provided with a visual or audio signal from the telephone base station that the wireless handset is in a low power state. A user interface may be provided on a display of the telephone base station which prompts a user to charge the wireless handset on a charging cradle of the telephone base station. At least one of the wireless handset and the headset may be a Bluetooth device.

In another general aspect, a computer-readable medium having computer-executable instructions contained therein for a method of managing a wireless handset associated with a IP telephone base station, the method including detecting an on-cradle or an off-cradle state for the wireless handset associated with the IP telephone base station; providing a voice data path to the wireless handset if the wireless handset is in the off-cradle state; and providing a voice date path which omits the wireless handset if the wireless handset is in the on-cradle state.

Implementations of this aspect may include one or more of the following features. For example, the computer readable medium may have computer-executable instructions contained therein for detecting an operational state of a headset associated with the IP telephone base station; alternatively providing a voice date path to the headset associated with the IP telephone base station if the headset is in an active state, providing a first user interface on a display of the telephone base station if the wireless handset is detected in the off-cradle state, the user interface including features for managing the wireless handset at the telephone base station, if the headset is detected to be in an active operational state, alternatively providing a second user interface on the display of the telephone base station which includes features for managing the headset at the telephone base station; receiving an indication of a power level of the wireless handset paired with the telephone base station; and/or providing a user with a visual or audio signal from the telephone base station that the wireless handset is in a low power state. The method may include providing a user interface on a display of the telephone base station which prompts a user to charge the wireless handset on a charging cradle of the telephone base station, and at least one of the wireless handset and the headset is a Bluetooth device.

In another general aspect, a method for pairing a Bluetooth wireless adapter with a IP telephone base station, the method comprising determining if a Bluetooth wireless adapter is detected in operative connection with the IP telephone base station. If the Bluetooth wireless adapter is detected, a parameter is set (LastBoot) to zero to indicate a most recent occurrence of the telephone base station being booted. If the Bluetooth wireless adapter is detected, a Bluetooth Device Address (BDA) of the detected adapter is compared to a stored Bluetooth Device Address (BDA) for a previously registered Bluetooth wireless adapter. A local wireless accessory is paired to the IP telephone base station.

Implementations of this aspect may include one or more of the following features. For example, pairing the local wireless accessory may include setting a radio power level of the Bluetooth wireless adapter to a relatively low level; scanning for local wireless accessories in a vicinity of the Bluetooth wireless adapter; registering a single, local wireless accessory in the vicinity of the Bluetooth wireless adapter; and/or increasing the radio power level of the Bluetooth wireless adapter to a relatively higher level and discontinuing any scanning for additional wireless accessories in the vicinity of the Bluetooth wireless adapter. Pairing the local wireless accessory to the IP telephone base station may include identifying if the local wireless accessory is at least one of a wireless handset or a wireless headset. The phone may be toggled between operation in a headset mode and a wireless handset mode through a user interface provided on the telephone base station, e.g., headset button, or wireless handset, CC button.

One or more of the foregoing aspects may provide one or more of the following advantages. For example, the present inventors have determined that there exists a need in the art for a telecommunications terminal that is easy to use with both wired and/or wireless accessories to provide the functionality of a user-friendly interface and/or mobile platform that may be incorporated into a local client device for telecommunications. A telephone station may incorporate a handset for a telephone base station which is adapted for local, wireless operation using, for example, the well-known Bluetooth wireless protocol. The telephone station may include various modular components, such as optional housings supporting wired and/or wireless operation of accessories and handsets. For example, in one implementation a first housing may include a display and keypad arranged thereon and a second housing which incorporates a handset cradle and a wireless interface. Accordingly, the telephone station can be converted back to a conventional design, e.g., in which the handset exchanges signals with the telephone circuitry over a wire connection, merely by removing the second housing and replacing it with a third housing having a cradle and interface connected through a wired connection, e.g., by wire pairs to a standard telephone handset.

A wireless implementation constructed in accordance with the one or more of the foregoing aspects may have the same aesthetic appearance as a traditional wired handset, with only a few additional features that are pertinent for wireless operation. For example, as in a conventional desktop station telephone, a cradle is defined upon the exterior surface region of the telephone station and, the cradle is dimensioned and arranged to receive and retain the handset during periods of either non-use or traditional speakerphone operation. However, the telephone base station provides the option of a wireless connection between the handset and phone in a telephone station. Instead, the cradle may incorporate a charging interface with electrical contacts engageable with mating contacts on the telephone handset, e.g., thereby allowing rechargeable battery cells within the handset to be charged while it is in the cradle.

For example, an exemplary Bluetooth implementation may include a Bluetooth adapter that plugs into an adapter interface of the telephone station housing for signaling information and the headset jack of the phone for audio transmission. The Bluetooth adapter may be adapted to support an alternate headset interface that is built into the adapter to allow for the connection of a wired headset or other audio device to the phone that would normally connect to the headset interface, Commands from the phone over the Adapter interface are used to direct the adapter to connect either Bluetooth related audio or analog audio from the alternate headset interface to the phone's headset jack. The adapter will be responsible for all communications with the mobile device, e.g., a Bluetooth handset or Bluetooth headset, and terminates all layers of the Bluetooth protocol. An enhanced protocol allows the phone and the Bluetooth adapter to exchange administrative, user interface (UI) and audio control messages. Accordingly, in an exemplary Bluetooth architecture, there are three components involved with any Bluetooth call: the phone, the adapter and the mobile device. The Bluetooth Adapter is preferably a Bluetooth Class 2 device and has a range of at least 10 meters (line of sight with no obstruction), but may have higher ranges depending on the transmission frequency and power utilized in the system. While the Bluetooth protocol is contemplated as a useful radio frequency standard for facilitating one or more aspects of the present invention, other radio frequency standards may be supported depending upon the requirements of a target network.

### BRIEF DESCRIPTION OF THE DRAWINGS

Further aspects and advantages will become apparent upon reading the following detailed description taken in conjunction with the accompanying drawings summarized below.

FIG. 1 is a plan view of an exemplary telephone having a display device and a wired telephone housing attached to a main telephone base station.

FIG. 2 is an exemplary screenshot of a display of the deskphone of FIG. 1.

FIG. 3 is an exemplary screenshot of a display of the deskphone of FIG. 1.

FIG. 4 is a schematic view of an exemplary IP deskphone.

FIG. 5 is a schematic view of an exemplary IP deskphone system which includes an optional wireless housing component, a wireless modular adapter configured for Bluetooth, and various wireless and/or wired accessories.

FIG. 6A is a front view of an exemplary wireless handset.

FIG. 6B is a rear review of the exemplary wireless handset of FIG. 6A.

FIG. 7 is a flowchart of an exemplary process for pairing a telephone base station and adapter for establishing a new pairing relationship which shows messaging between phone-side activities and adapter-side activities.

FIG. 8 is a flowchart of an exemplary process for determining adapter condition for pairing with the wireless modular adapter and telephone base station.

FIG. 9 is a flowchart of an exemplary process for administering and/or pairing a Bluetooth Adapter with a telephone base station.

FIG. 10 is a flowchart of an exemplary process for a handset locator/finder feature for a system including a telephone base station and a wireless handset as shown in FIGS. 6A-6B.

FIG. 11A is an exemplary screenshot of a user interface indicating an operational state of the wireless modular adapter.

FIG. 11B is an exemplary screenshot of a user interface initiating a pairing process and indicating the status of any detected wireless devices.

FIG. 12A is an exemplary screenshot of a user interface prompting a user to select a device for a pairing process.

FIG. 12B is an exemplary screenshot of a user interface prompting a user to designate or select a device name for a subsequent pairing process.

FIG. 13A is an exemplary screenshot of a user interface prompting a user to initiate a step within a pairing process for a first device.

FIG. 13B is an exemplary screenshot of a user interface prompting a user to initiate a step within a pairing process for a second device.

FIG. 14A is an exemplary screenshot of a user interface prompting a user to initiate a step within a pairing process for an unregistered or unrecognized device.

FIG. 14B is an exemplary screenshot of a user interface prompting a user to enter or designate a passkey or other unique identifier.

FIG. 15A is an exemplary screenshot of a user interface notifying a user that the pairing process for a device has been completed.

FIG. 15B is an exemplary screenshot of a user interface notifying a user of an error within the pairing process for a device.

FIG. 15C is an exemplary screenshot of a user interface notifying a user of the activation of the handset finder function.

### DETAILED DESCRIPTION

Embodiments consistent with the present invention are more specifically set forth in the following description with reference to the appended figures. Wherever possible, the same reference numbers will be used throughout the drawings to refer to the same or like parts.

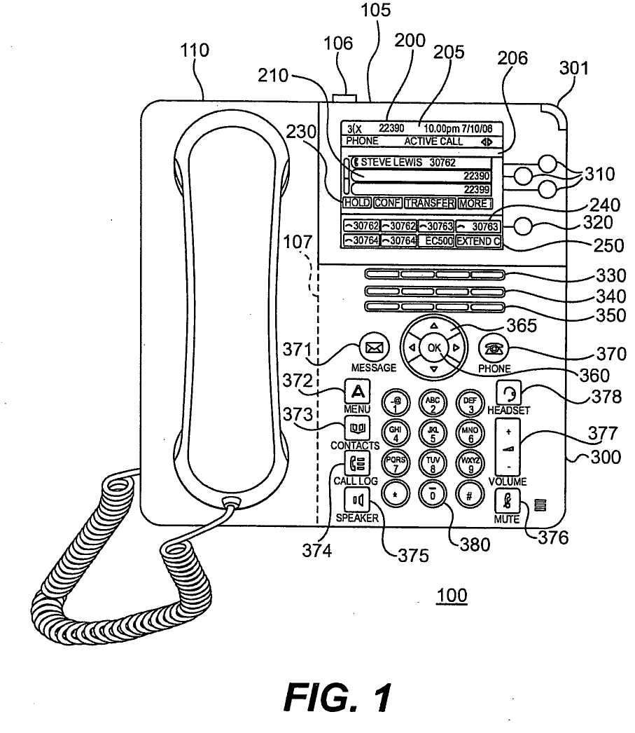

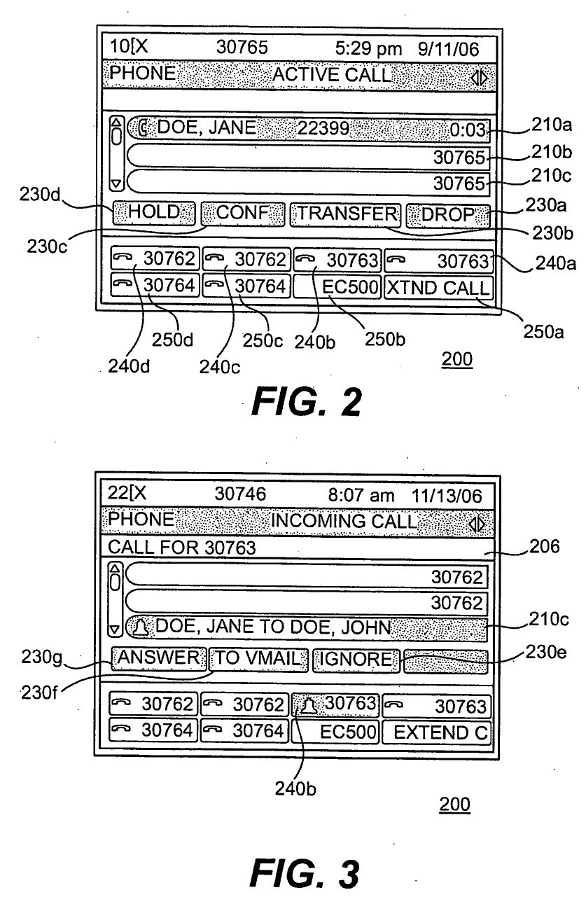

The Bluetooth adapter is a device that plugs into the base of a telephone station and provides the Audio Gateway (AG) function in a Bluetooth environment that involves wireless headsets and handsets. It provides the full support of the applicable Bluetooth protocol stack. The adapter terminates the Bluetooth protocol but works with the phone for all user interface-related issues. It is connected to the phone in two ways: the “Adapter Interface” provides a means for all administrative and functional signaling between the phone and the adapter. Power is also provided over this interface. The second interface to the phone is for transmitting and receiving audio by means of the headset jack on the phone. A short 4-wire cable provides physical connection of the adapter to the headset interface. The adapter will also have a jack to which a wired headset can be attached. This jack will provide the same interface to a headset that the telephone that the adapter plugs into normally provides (including support for 7 KHz audio). The adapter, under phone control, will be able to switch the audio path between the Bluetooth audio stream and the wired headset audio stream. FIG. 1, below, provides a high-level block diagram of the adapter and how it connects to the phone.

Referring to FIG. 1, an exemplary deskphone 100 includes a display 200 and a keypad portion 300. Although the following exemplary embodiment is described in connection with a VoIP deskphone, one or more features of the following description is applicable to various types of phones, including walkup or lobby phones, cordless phones, and/or other handheld devices, such as personal digital assistants (PDAs). The keypad portion 300 includes a standard alphanumeric telephone keypad 380 for inputting numbers for calls, activating various features, and/or input of text. The keypad portion 300 includes a message button 371, a phone button 370, and a user navigation device, which includes exemplary directional arrows 365, and a select or OK button 360 for activating audio menu options and/or features selectable from the display 200. The message button 371 permits the user to access voicemail messages and the phone button 370 permits the user to access information relating to active calls.

The deskphone 100 includes a menu button 372, contacts button 373, call log button 374, and speaker button 375, which each provide the user with access to various functions of the deskphone 100. The menu button 372 provides the user with access to adjust and customize options and settings for the telephone, to access Web-based applications, to obtain information about phone or network settings, and/or to log out of the menu feature. The accessible options are typically designated by a system administrator or by the manufacturer dependent upon network capabilities and the level of access and features appropriate for the client device and/or user. Alternatively, or additionally, the accessible options may be adjusted locally at the client device by a user provided with the appropriate level of network access to alter settings on the client device. The contacts button 373 provides access to a list of stored contacts, e.g., for viewing or editing, and the call log button 374 permits the user to view one or more lists relating to the most recent incoming, outgoing, and/or missed calls. The speaker button 375 activates or deactivates the speaker option for the telephone.

The keypad portion 300 also includes a headset option 378, volume adjustment 377, mute button 376 for muting an active call, and a message waiting indicator 301 which provides the user with an indication of voice, email, and/or text messages waiting for the user. The headset option 378 toggles the telephone between a handset/speaker mode and a headset mode for listening to calls and messages. The volume adjustment 377 adjusts the master volume for the deskphone 100. Alternatively, or additionally, volume options may be provided through the activation of the menu button 372 and/or through selectable options on the display 200.

The display 200 includes a status line 205 which may contain information relating to a number of missed calls, a relevant extension number of the most recent missed call, and a date and time field. A prompt line 206 contains information relating to a current call, such as an extension of an active or incoming call, and one or more application lines 210 provide information relating to available lines or extensions, e.g., call information, such as an incoming caller's name and a recipient users extension or name. The application lines 210 are activated with line buttons 310 which allow the user to select an active application line. For example, a highlighted line is shown in FIG. 1 which indicates that a call from “Steve Lewis 30762” is currently active or selected by the user of the deskphone 100.

The display 200 includes a softkey label array which includes softkey labels 230 and auxiliary softkey labels 240, 250. The softkey labels 230 are icons automatically generated and presented to the user depending upon the status of the deskphone 100. For example, the softkey labels 230 shown in FIG. 1, including the [Hold], [Conf], [Transfer], and [More] icons, are indicative of available actions which are presented to the user on the display 200 since the line button 310 associated with the 30762 (Steve Lewis) call has been selected by the user. The auxiliary softkey labels 240, 250 are icons which are automatically generated and presented to the user responsive to a user input to an auxiliary shift button 320. For example, the display 200 includes one row of four softkey labels 230 and two rows of auxiliary softkey labels 240, 250, each containing four icons. Accordingly, the viewable set of auxiliary softkey labels are changed each time the auxiliary shift button 320 is activated by the user, e.g., a new set of eight auxiliary softkey labels is presented to the user. While one auxiliary shift button 320 is shown in FIG. 1, an additional auxiliary shift button 320 may be provided on the opposite side of the display 200, e.g., in a mirrored position on the left side of the display 200 with respect to the auxiliary shift button 320 which is shown positioned on the right side of the display 200.

If two or more auxiliary shift buttons 320 are provided, each may be provided with alternative scrolling capabilities, e.g., another auxiliary shift button 320 positioned on the left side of the display 200 may be configured to provide backward scrolling through sets of auxiliary softkey labels 240, 250 and the auxiliary shift button positioned on the right side of the display 200 may be configured to provide forward scrolling through sets of auxiliary softkey labels, 240, 250. The softkey labels 230 and auxiliary softkey labels 240, 250 may be preprogrammed into the deskphone 200 by a system administrator, the user of the telephone, and/or any other authorized user. The softkey labels 230 and auxiliary softkey labels 240, 250 are programmed to correspond to additional bridged extensions, dial buttons, call options, or any other phone feature or option available for managing calls, call information, and/or additional phone terminals, e.g., such as external phone terminals such as user's cellular telephone. The softkey labels 230 and auxiliary softkey labels 240, 250 may include graphical icons, keywords, alphanumeric identifiers, and/or any combination thereof for each function which is displayed at each softkey label 230, 240, 250.

While the softkey labels 230 typically appear automatically in response to the active status of the deskphone 100, the auxiliary softkey labels 240, 250 that are displayed are controllable by the user through the auxiliary shift button(s) 320. However, one or more of the rows of auxiliary softkey labels 240, 250 may be configured to be automatically displayed dependent upon the active status of the deskphone 100, and the auxiliary shift button(s) 320 may be optionally provided in the particular deskphone 100. Alternatively, the display of the softkey labels 230 may also be controlled through the use of another shift button, e.g., similar to auxiliary shift button 320 (but not shown). Accordingly, the user may be automatically presented with twelve immediately accessible features or options that may be displayed based on the active status of the deskphone 100 and/or based on inputs received at an auxiliary shift button(s) 320. In addition, the options may be selectively and/or automatically changed based on changes in the status of the deskphone 100, e.g., the user shifts from managing voicemail messages to engaging a call with another user on another client device.

The deskphone 100 also includes a button array which includes softkey buttons 330, and two rows of auxiliary softkey buttons 340, 350. Referring to FIG. 1, the button array is shown having one row of four softkey buttons 330 which correspond to and are positioned so as to be substantially horizontally aligned with the row of softkey labels 230 positioned above the button array and on the display 200, e.g., an individual column of softkey labels 230, 240, 250 is horizontally aligned with a corresponding column of softkey buttons 330, 340, 350 about a common vertical axis extending through the column. However, since the button array may include buttons that are slightly larger than the corresponding softkey labels to facilitate easier manipulation with a user's fingers, the button array and softkey label array may be slightly misaligned to account for the difference in size between the two arrays (e.g., as shown in FIG. 1).

The button array may include two or more rows of auxiliary softkey buttons 340, 350. Each row of auxiliary softkey buttons 340, 350 contains four auxiliary softkey buttons which correspond to, and are positioned so as to be substantially horizontally aligned with the two rows of auxiliary softkey labels 240, 250 on the display 200. Accordingly, the various softkey labels 230, 240, 250 and corresponding softkey buttons 330, 340, 350 may be sized and shaped to have similar appearances so that the user intuitively associates the corresponding softkey buttons 330, 340, 350 with the appropriate softkey labels 230, 240, 250 in the softkey label array.

One or more rows of buttons 330, 340, 350 may include illumination elements, such as internal LEDs which provide backlighting through a relatively clear or translucent cover forming the buttons. Whenever a function icon is activated by the user or system, the appropriate button in the button array would be illuminated. Alternatively, or additionally, the corresponding softkey labels 230 or auxiliary softkey labels 240, 250 may be highlighted and/or presented in various fonts, such as, for example, italics, various colors, underlined, and/or in bold-faced type. For example, if the softkey label array includes two row of icons with three icons per row (or four icons per row as shown in FIG. 1), the button array would include two rows of corresponding buttons with three buttons per row (or four buttons per row as shown in FIG. 1). If the user toggles the array of auxiliary softkey labels 240, 250 to bring up a new set of available softkey labels 240, 250, the corresponding auxiliary buttons 340, 350 may be illuminated based on whether a particular setting or feature has been designated, e.g., a “mute” function shown as an available auxiliary softkey label may result in the corresponding auxiliary softkey button being illuminated if the mute option is activated, and appear non-illuminated if the mute option is currently not selected by the user. Accordingly, the button array and softkey label arrays serve as intuitive, visual indicators of the current status of numerous functions/settings within a single view of a user interface.

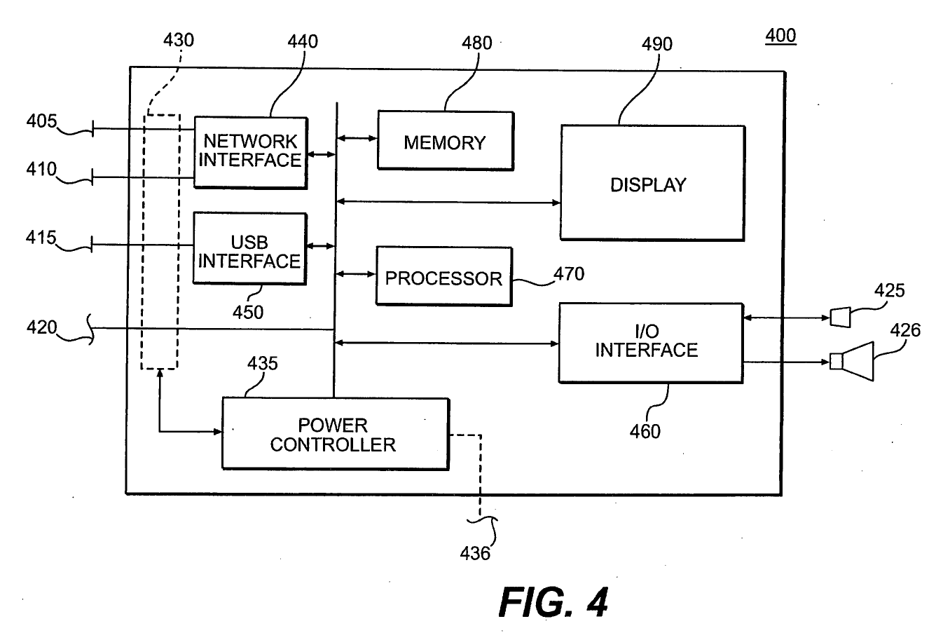

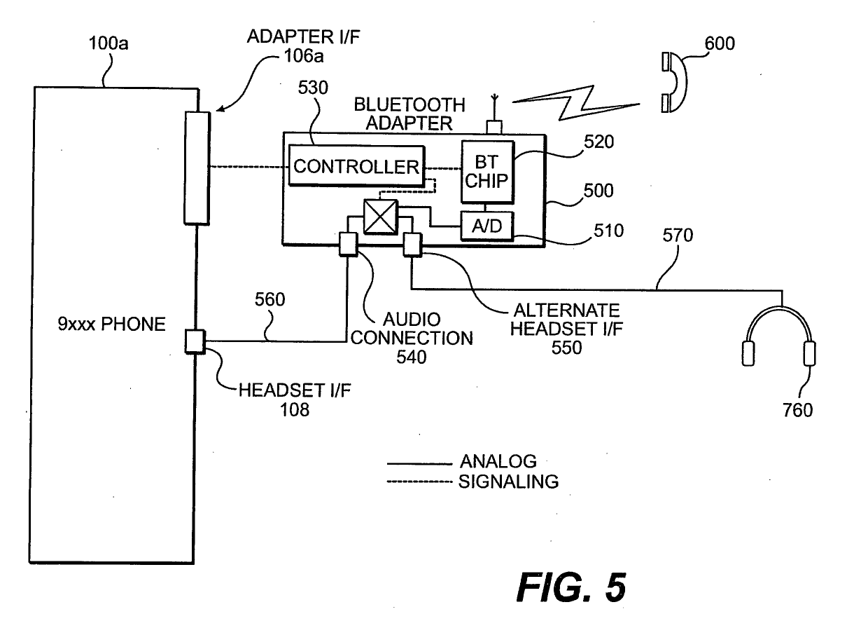

Referring to FIG. 4, an exemplary telephone base station 400, such as a VoIP telephone, e.g., an Avaya One-X deskphone, such as a 96xx series IP phone, includes a processor 470, a memory 480, a display 490, and an input/output interface 460. In addition, the VoIP phone 400 may include a network interface 440 for sending and receiving data over a network connection, e.g., such as a standard RJ-45 Ethernet connection. The processor 470 may include one or more processors for controlling, interpreting, and/or processing data exchanged between the VoIP telephone 400 and the network. The memory 480 may be one or more memory devices or media capable of storing data or instructions. Although the VoIP telephone 400 is depicted as including each of the components shown in FIG. 4, the VoIP phone may integrate one or more of the components shown in FIG. 4, such as through an integrated processing device or module, e.g., an analog telephony adapter (ATA) and/or combination of client software residing in memory 480. The ATA and/or client software may utilize audio codecs to handle data packet conversion, e.g., digital-to-analog conversion of incoming voice data. One or more VoIP protocols, such as, for example, H.323, may be used to define ways in which video, audio, and/or data is processed and/or transferred through the network using VoIP. The VoIP telephone 400 may also include a combination of hardware and software similar to that described in connection with FIG. 3 for detecting power and available power supplies.

The display 490 provides the user of the VoIP telephone 400 the ability to view call information, power management information, to review and/or conduct messaging (such as text or email messaging), and/or may serve as a user interface, e.g., such as a graphical user interface and/or touchscreen for managing associated accessories that may be connected to the phone 400, e.g., wireless Bluetooth handsets, wired or wireless Bluetooth headsets. The input/output interface 460 is shown as a monolithic device operably connected to a microphone 425 and a speaker 426, e.g., such as in a VoIP handset (not shown). However, the input/output interface 460 may include one or more individual and separate components, for example, such as an analog-to-digital converter for converting analog audio signals input through the microphone 425 to digital data, and/or a digital-to-analog converter for converting digital data to analog audio signals which is output through the speaker 426, such as through a VoIP handset.

The VoIP phone 400 may be used to make telephone calls over the internet through a standard network connection. Accordingly, the VoIP phone 400 includes one or more Ethernet connections 405, 410, e.g., such as RJ-45 Ethernet connectors. The Ethernet connections 405, 410 permit the phone 400 to exchange data and/or receive power, such as PoE, through a single connection, e.g., a twisted pair, CAT5e Ethernet cabling, and a modular connection. Alternatively, or additionally, the VoIP phone 400 may include an external power supply connection 420, for example, for connecting to an external wall outlet through an AC/DC or other wall adapter to provide an independent power supply for each networked client device. Alternatively, or in addition, the VoIP phone 400 may include similar software and/or hardware as that described with respect to gigabit switch 205 and shown in FIG. 3.

In addition, the VoIP phone 400 may include a USB port 415 and USB interface 450 for connecting a variety of peripheral devices, such as, for example, memory devices, cellular telephones, personal digital assistants (PDAs), and/or night lights. In addition, the USB port 415 may instead be configured as a separate accessory port, e.g., to connect a wireless Bluetooth modular adapter. Although many peripheral devices connecting through the USB port 415 may be provided with independent or integrated power supplies, some peripheral devices may draw power through the VoIP phone 400, such as for charging the internal power supply of a PDA connected through the USB port 415. Peripheral devices drawing power through the USB port 415 may draw varying amounts of power, e.g., typically 2.5 W or less, through the VoIP phone 400 and the power source being used by the VoIP phone 400, e.g., through an AC/DC wall adapter if connected through connection 420 or through the Ethernet (PoE).

If the VoIP phone 400 is being powered in a PoE mode, power supply issues may arise for the VoIP phone 400 and/or the network to which the VoIP phone 400 is connected to and drawing power. For example, if a user plugs a peripheral device into the USB port 415, such as a PDA that recharges an internal battery while connected through the USB port 415, one or more power supply issues may arise if the VoIP phone 400 is receiving PoE. If the VoIP phone 400 is only receiving enough power from the PoE source to power the VoIP phone 400, the addition of peripheral devices can overload and/or damage the power supply of the PoE, overheat the network connections or cables, and/or cause unexpected drops in the voltage level of the PoE that may lead to software errors and/or resetting of one or more other networked devices, including the VoIP phone 400. Alternatively, the user may require faster data transfer rates through the VoIP phone 400, which may necessitate operating off of an independent power supply, e.g., so that all of the twisted pairs of the Ethernet connection are being utilized for data transfer and not data and PoE.

Accordingly, the VoIP phone may include one or more power detectors 430, a power controller 435 for executing software for detecting the power source and designating a power signature for the VoIP phone 400, and/or a PoE power signature switch 436 enabling the user and/or software to manually adjust the power signature, e.g., PoE power classification 0, 1, 2, 3 and/or 4, and to monitor the power status of connected peripheral devices or accessories, such as a wireless Bluetooth handset associated with the telephone 400. However, it will be appreciated that the power controller 435 and any other process controllers associated with various functions of the VoIP phone 400 may be accomplished by a microprocessor which integrates the various controllers within a single monolithic device, such as processor 470. The VoIP phone 400 may include one or more power detectors 430 for sensing the presence of power through one of the power sources, e.g., whether the VoIP phone 400 is receiving power through the AC/DC wall adapter connection 420 or through PoE. The power detector 430 may include a sensor or sensors for detecting the flow of current through each of the various power connections, e.g., a donut-shaped coil surrounding each conducting wire(s) or conducting pin passing through the coil.

If the VoIP phone 400 is receiving power through an independent power supply, such as through an AC/DC adapter connected to the connection 420, the power controller 430 may process software enabling the VoIP phone to also power peripheral devices through the USB port 415. Alternatively, or in addition, if the VoIP phone 400 is receiving power through PoE, the VoIP phone 400 may prompt the user to disconnect the USB port 415, connect an independent power supply through connection 420, and/or to adjust the power signature of the VoIP phone manually, e.g., move switch 436 positioned on the housing of the VoIP phone 400 to a higher power classification supporting peripheral devices, e.g., from a PoE class 2 signature to a PoE class 3 signature. Alternatively, or in addition, the VoIP phone 400 may automatically disable and/or adjust the power signature of the VoIP phone 400, e.g., through software residing within the phone and managed by the power controller 435.

In addition, or alternatively, the power detector 430 may include a sensor or sensors determining if a peripheral device connected through the USB port 415 is drawing power through the VoIP phone and USB interface 450. The power detector 430 may include sensors for each power source and/or for each USB port 415 provided on the VoIP phone 400. For example, if the VoIP phone 400 is provided with an Ethernet port 405, an AC/DC adapter connection 420 (or AC power connection with internal AC/DC transformer within the VoIP phone 400), and a pair of USB ports 415, the power detector 430 may include four independent sensors configured to detect current levels or power through the respective connections. Alternatively, the power detector 430 may include an integrated power detection module (as shown in FIG. 4) detecting current and/or power for each power source and device drawing power through the VoIP phone 400. Accordingly, one or more of the sensors may be configured to only detect current flow and/or actually measure current passing through the sensor, e.g., such as a donut-shaped coil surrounding the conducting wire and configured to detect and measure current passing through the conducting wire in a manner similar to a FLUKE™ clamp meter.

The power controller 435 determines the presence of current flowing within the powering wire of the USB port 415, e.g., to determine the active power source, and/or measures a total power or current draw for the VoIP phone 400 and any peripheral devices connected through the USB port 415, e.g., to determine the total power consumption for the VoIP phone 400. Alternatively, or in addition, the power controller 430 may determine the collective power draw of the VoIP phone 400, including any adapters, modules, and/or peripheral devices, each time the VoIP phone 400 is reset and/or each time an adapter, module, and/or peripheral device is connected or disconnected from the VoIP phone 400. The power controller 430 and/or processor 470 may monitor the USB port 415 and enable or disable the USB port 415 based upon actual real time power usage measurements at the USB port 415. Accordingly, the remainder of the network is protected from over current situations, such as when operating the VoIP phone 400 off of PoE.

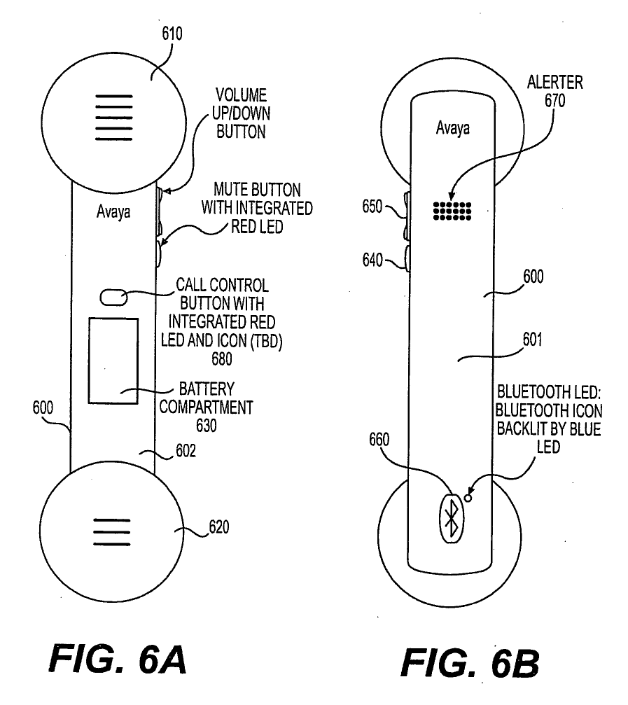

Referring to FIG. 5, an exemplary modular system includes a wireless accessory housing 100a for the phone 400, a wireless adapter module 500, a wireless handset 600, and an optional headset (wired or wireless) 760. Referring to FIG. 1, the phone 400 may incorporate a modular design that permits the selective engagement of the wireless accessory housing 100a with a primary housing body 105 to facilitate the use of wireless accessories and/or the engagement of a wired handset housing 110 that may be physically removed from the primary housing 105, e.g., the housing 110 left of a parting line 107 shown in FIG. 1 may all be physically detached from the primary housing 105 to facilitate the insertion of an alternative housing, e.g., such as the accessory housing 100a shown in FIG. 5. A wireless adapter port 106, e.g., for plug-in receipt of a wireless adapter module 500, may be incorporated into the primary housing 105 (as shown in FIG. 1) or into the wireless accessory housing 100 for receiving an accessory adapter configured to support and terminate all layers of the supported wireless protocol, e.g., Bluetooth protocol, and related communications.

The adapter module 500 plugs into an adapter port 106 of the phone 400 which includes an adapter interface 106a for handling for audio/voice signaling data between wireless accessories connected through the adapter module 500. The housing 100a of the phone 400 may also include a headset interface 108 supporting a wired headset jack of the phone for audio transmission via wired connection with the headset 760. If the headset 760 is a wireless headset 760, the headset may be partially wired via the adapter module 500 to the phone 400 or communicate wirelessly through the adapter module 760. By providing at least a wired connection 560 between the module 500 and the headset interface 108 of the phone 400, the headset button 378 on the phone 400 may still be used to control headset operation and/or toggle between handset operation or headset operation (wired or wireless headset). For example, to allow for the connection of a wired headset or other audio device to the phone that would normally connect to the headset interface, the adapter 500 is also preferably adapted to support an alternate headset interface(s) 540, 550 that is built into the adapter module 500.

Commands from the phone 400 over the adapter interface 106a are used to direct the adapter 500 to connect either Bluetooth related audio or analog audio from the alternate headset interface to the phone's headset interface, e.g., the phone's headset jack 108. The adapter 500 is responsible for all communications with any associated mobile devices, e.g., a Bluetooth handset or Bluetooth headset, and terminates all layers of the Bluetooth protocol. An enhanced protocol allows the phone and the Bluetooth adapter to exchange administrative, user interface (UI), and/or audio control messages. The adapter 500 is preferably a Bluetooth Class 2 device having a range of at least 10 meters, e.g., line of sight with no obstruction, or more. However, other radio frequency standards, such as variants employing frequency hopping standards which allow multiple devices in the same vicinity to operate without interfering with one another.

The adapter 500 is a device that plugs into the base of a telephone station housing component and provides the Audio Gateway (AG) function in a Bluetooth environment that involves wireless headsets and handsets. It provides the full support of the applicable Bluetooth protocol stack. The adapter 500 terminates the Bluetooth protocol but works with the phone for all user interface-related issues. The adapter 500 is connected to the phone 400 in two ways, e.g., the adapter interface 106a provides a conduit for all administrative and functional signaling between the phone 400 and the adapter 500. Power, such as charging power from the phone 400 provided through an A/C adapter or PoE, is also provided over this interface 106a. The second interface 108 to the phone is for transmitting and receiving audio by the headset jack on the phone. A short 4-wire cable 560 provides physical connection of the adapter 500 to the headset interface 108. The adapter 500 will also have a jack 550 to which a wired headset 760 can be attached via cable 570. The jack 550 will provide the same interface to a headset that the telephone provides to the adapter which normally plugs into the headset 760 (including support for 7 KHz audio). The adapter 500, under phone control, is able to switch the audio path between a Bluetooth audio stream and the wired headset audio stream.

Referring to FIG. 5, the adapter 500 may include various components which manage all layers of the Bluetooth protocol. For example, the adapter 500 may include a Bluetooth microprocessor chip 520 with memory and logic, an analog to digital converter(s) 510, headset interfaces 540, 550, a controller 530 and transmission components, e.g., a transceiver for transmitting and receiving RF signals at approximately 2.45 gigahertz. The headset interface 108 on a 4-position, 4-conductor modular jack identified by a headset icon. The headset interface 108 is connected to circuitry within the station housing 100a capable of supporting both 3 KHz and 7 KHz transmit and receive. The interface 108 preferably has the ability to receive a switch hook control message and then transmit a corresponding HdSet_off_hook_Req or HdSet_on_hook_Req message over the Adapter interface.

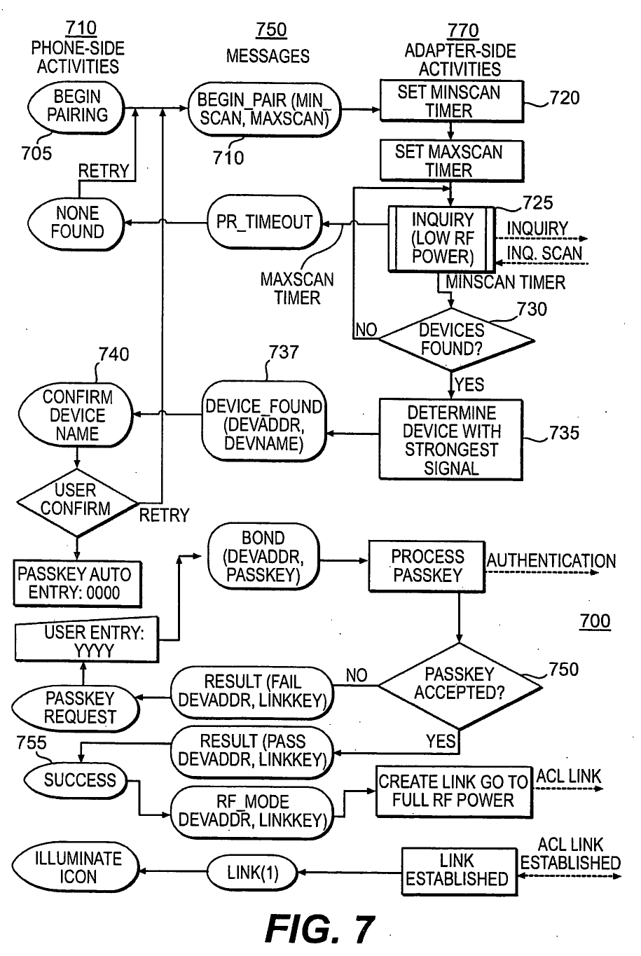

Referring to FIGS. 6A and 6B, an exemplary handset 600 includes a mouthpiece 620, and earpiece 610, a call control button 680, an alerter 670 that supports an audio or visual signal useful in locating an off-cradle handset, a mute button 640, a volume control button 650 and a battery compartment, e.g., which contains rechargeable battery cells. A rear side 601 of the handset 600 includes a Bluetooth LED 660 that may include a Bluetooth icon that is backlight with color LED, e.g., blue, to indicate connectivity of the handset 600. A front side 602 of the handset 600 includes the battery compartment 630 and call button 680.

The mouthpiece 620 includes a microphone at one end and the earpiece 610 includes a speaker. The mute button 640 may have an integrated LED indicator adapted to indicate to a user whether or not the mute operation has been selected. The call control button 680 may include an integrated LED indicator may be used to control an active call, e.g., switch between an active call and an incoming call. Power, Batteries. Wiring, and Radio.

Power to the wireless handset 600 may be provided in two ways depending upon whether the handset 600 is within the cradle (exemplary cradle shown in FIG. 1), e.g., on-cradle mode, and in the attached mode, e.g., the aforementioned wired housing implementation 110, or a stand-alone mode. When in attached mode, the charging cradle will be provided power via pins of a module interface jack of the housing 100, 100a, e.g., the aforementioned wireless housing configuration. The cradle is capable of passing power to subsequent daisy chained modules to include up to three additional button modules and/or a keyboard. The charging cradle is adapted to accept a software command from the phone 400 to tell it to turn off charging capability. As described earlier, the charging cradle provides information to the host telephone 400 of its existence as well as its power requirements, e.g., both maximum draw when charging is enabled and minimum draw when charging has been disabled in a format that allows for power to be represented as xx.yy Watts.

Alternatively, the cradle will also be able to receive power from an aux power supply, such as through PoE and/or through an AC/DC adapter power source connected through the phone 400 and/or directly to the housing 101a. If both power sources are connected at the same time, the cradle will draw power from the aux power supply and power 400 from the phone is ignored. In this situation, the cradle reports its power consumption to the phone as if it were powered from the phone. Also, if the cradle receives a message from the phone to go to low power, it will comply by turning off power to the charging contacts. If the cradle is in attached mode and no aux power supply is connected to the cradle, voltage at the aux power connector will be reduced or shut off.

The charging contacts for both the charging cradle and the handset may be designed such that touching them will not harm the device or the person who touches them. The circuitry for the handset will be able to detect two low battery conditions and pass this information to the user interface of the handset via appropriate messaging. For example, the first condition may be when the battery has approximately one hour of talk-time remaining. The second condition may be defined as approximately 15 minutes of talk time remaining. The circuitry for the handset detects the presence of charging voltage at the charging contacts and passes this information to the user interface.

The circuitry for the handset 600 detects when the handset 600 has been lifted from the cradle and passes this information to the user interface. The methodology to determine should not rely exclusively on the detection of loss of charging current/voltage, but rather take into account the potential for loss of power to the charging cradle while the handset 600 is still in it. For example, the loss of AC power should not result in a false-positive indication that the handset 600 has been removed from the cradle. Where the cradle is aux-powered, power has been disrupted (e.g., either loss of AC power or the aux power supply is unplugged), and the phone is ringing or active on a call, the system will not accommodate transfer of the call to the Bluetooth handset.

The handset 600 will support all mandatory components of Headset Profile [Part K:6 of Bluetooth 1.1] for an HF device. As indicated previously, however, there are some features that are to be provided by the handset 600 that are not supported by the Headset Profile. These are to be provided by means of extensions to the Headset profile. The extensions used will not impact the ability of the handset to be BQB certified (or equivalent per PRD 2.0) as a Bluetooth device.

An exemplary system, e.g., adapter 500, handset 600, and phone 400 may include one or more of the following features that may be initiated and/or controlled through the adapter 500, e.g., controller 530, chip 520, to permit initiating and/or terminating alerting from the AG, initiating an on/off hook condition from the handset to the AG, receiving an on/off hook command from the AG, a handset finder or locator feature, an indication of handset status, e.g., on-cradle or off-cradle, and/or an indication of battery condition, e.g., a Low Battery condition.

One or more of the foregoing implementations may include one or more of the following features.

Registration of the Adapter 500 with the Phone 400

The adapter 500 is configured to performs a “soft-start” to limit initial current and allow the “hot plugging” of the adapter 500 into the phone 400 without requiring a reset of the phone 400. Current may be limited to a predetermined threshold, e.g., 6 mA, so that the start-up process initializes in a Low Power mode characterized by no Bluetooth circuitry being active. The adapter 500 will stay in this mode until the phone 400 indicates that it is OK to transition to a higher power mode, e.g., with Bluetooth functionality enabled.

A low power mode is used until the phone 400 determines that the phone 400 can handle a higher total power usage with the current power class setting, e.g., PoE power class setting. Once the phone 400 determines that the PoE power class is adequate to support the aggregate power of all attached devices the phone 400 tells any associated modules, e.g., adapter module 500, to switch to full power.

The adapter 500 may be inserted or removed at any time. If the adapter 500 is removed, the phone 400 will be responsible for restoring pairing information using an RF_Mode command.

Power Management of the Interface

Parameters are included as part of a Discovery message between the Bluetooth adapter 500 and the phone 400 to inform the phone 400 of the maximum and minimum amount of power that the adapter 500 will consume. The maximum amount of power is defined as the amount of power that is required when all processors and the Bluetooth radio are active and consuming their maximum amount of power. Minimum power is defined as the amount of power consumed when in the Low Power mode. Full Power mode is the mode at which the adapter 500 is allowed to consume the maximum amount of power to provide full Bluetooth and analog functionality. The adapter 500 enters this power mode when the phone 400 instructs the adapter 500 to do so via a message as part of a Common Module Control message set. When the adapter 500 initially boots up after connecting with the phone 400, the adapter 500 will be in Low Power mode, defined as the state in which power is available for the processor for communicating with the phone 400 as well as drive the analog audio circuitry. However, no Bluetooth components are operational during the Low Power Mode. The adapter 500 enters the power mode when the phone 400 instructs the adapter 500 to do so via a message as part of the Common Module Control message set.

Accordingly, the adapter 500 may include or support one or more software-readable parameters. For example, the adapter 500 may support one or more of the software-readable parameters, e.g., not reprogrammable via downloading over the adapter interface 106a, described in greater detail in Table I.

TABLE I

| | Minimum Storage |
|---|---|
| Parameter | Requirement |
| the adapter model identifier (the first 8 characters | 8 alphanumeric |
| of the adapter's apparatus code) | characters |
| the adapter (unit) serial number | 18 alphanumeric |
| (as labeled on the lower housing of the adapter) | characters |
| the adapter (unit) Material ID (comcode) | 9 numeric |
| (as labeled on the lower housing of the adapter) | characters |
| Hardware vintage number | 1 octet |
| Model Generation | 1 octet |
| Software vintage number | 1 octet |
| Bluetooth Device Address | 48 bits |
| Maximum power consumption, see 9xxxBTA.2.5.100 | TBD |
| Minimum power consumption, see 9xxxBTA.2.5.100 | TBD |

All unused character locations will be filled with null characters (hex 00).

The adapter 500 may support the required components for an AG of Headset Profile. As described in greater detail hereinafter, some handset features that are not supported by the Headset Profile. The features are provided by extensions to the Headset profile. However, the extensions used will not impact the ability of the handset 600 to be certified (BQB or equivalent) as a Bluetooth device.

The adapter 500 and phone 400 are able to communicate to support adapter discovery and administration. Below is an illustrative summary of messages and content capable of supporting these activities. The Discovery protocol is described in more detail hereinafter. If additional messages are required for proper operation, e.g., ACKs, status, etc., additional messages can be added or modifications to these messages made without departing from the spirit and scope of the invention. Table II includes some exemplary Discovery and Audio_Chk messages that define an exemplary Discovery protocol.

TABLE II

| Message | Parameters | Direction | Comment |
|---|---|---|---|
| Discovery | the adapter model identifier | To Phone | Max power assumes all |
| | (the first 8 characters of the | | components of adapter |
| | adapter's apparatus code) | | fully operational; Min |
| | the adapter (unit) serial | | power assumes no power |
| | number | | to Bluetooth, but |
| | the adapter (unit) Material ID | | processing and control of |
| | (comcode) | | audio paths still possible |
| | Hardware vintage number | | Device address is used to |
| | Model Generation | | determine if the adapter |
| | Software vintage number | | was previously installed |
| | Bluetooth Device Address | | in the phone. |
| | Maximum power consumption | | |
| | Minimum power consumption | | |
| Audio_Chk | None | To Adapter | Tells the adapter to send an |
| | | | on-hook request to the |
| | | | phone. |

A user of a telephone station 400 may also wish to utilize a conventional wireless headset, e.g., instead of a wired headset. However, it will be appreciated by those skilled in the art that certain call handling operations may be associated with a wireless headset that are not associated with a wireless handset and vice versa. Every Bluetooth device, for example, has a unique Bluetooth Device Address (BDA) assigned to it during the manufacturing process. The BDA address cannot be changed. The BDA is usually displayed in hexadecimal format, e.g., 00:D0:B7:03:2 E:9F is a valid BDA. The Bluetooth Adapter will preferably allow only one Bluetooth device (i.e., handset or headset) to be registered (paired) at any given time.

Bluetooth Pairing Messages

Table III includes a summary of illustrative messages and content that support the ability of the adapter 500 to pair with a Bluetooth device.

TABLE III

| Message | Parameters | Direction | Comment |
|---|---|---|---|
| Begin_Pair | MaxScan | To Adapter | MaxScan is the time allowed |
| | | | to be in scan mode; its |
| | | | default value is 60 seconds. |
| | MinScan | | MinScan is the minimum |
| | | | amount of time that is |
| | | | allocated for scanning before |
| | | | the found device is reported |
| | | | to the phone. An illustrative |
| | | | default value is 5 seconds. |
| Device_found | User | To Phone | User friendly name is a name |
| | Friendly | | stored by the BT device, for |
| | Name | | example BTH01 and is |
| | | | reported by the device to the |
| | | | AG as part of the pairing |
| | | | process. |
| | BT Device | | BT device address is the |
| | Address | | device address of the paired |
| | | | device. |
| Pr_Timout | | To Phone | Indicates that the pairing |
| | | | process has timed out |
| Bond | BT Device | To Adapter | The passkey for the BT |
| | Address | | device as entered by the user |
| | PassKey | | |
| | <up to 16 | | |
| | digits> | | |
| Result | Pass/Fail | To Phone | Indicates that the BT device |
| | BT Device | | has accepted/rejected the |
| | Address | | user-entered passkey and |
| | Link Key | | includes link key information |
| RF_MODE | BT Device | To Adapter | Tell the BT device to go to |
| | Address | | appropriate power mode and |
| | Link Key | | begin normal mode after |
| | | | pairing |
| Stop | | To Adapter | Tells adapter to stop the |
| | | | Inquiry process |

In one exemplary system, the wireless interface (adapter) 500 utilizes a “User Friendly Name” (Device_Found message) to determine which device is active. Advantageously, this arrangement enables the telephone station 400 to make use of a common Bluetooth profile for both the handset 600 and the headset 760 despite the fact that certain call control procedures are not common to both. For example, this arrangement overcomes the inability of the Bluetooth profile itself to accommodate such control selectivity. An exemplary phone 400 may use the Bluetooth User Friendly Name for both user feedback for pairing as well as to determine if the paired device is a headset 760 or a handset 600. The adapter 500 uses standard Bluetooth commands to determine the name and pass the name to the phone 400 during the pairing process as a parameter of the Device_Found message.

Pairing of the Interface/Adapter and Handset or Headset

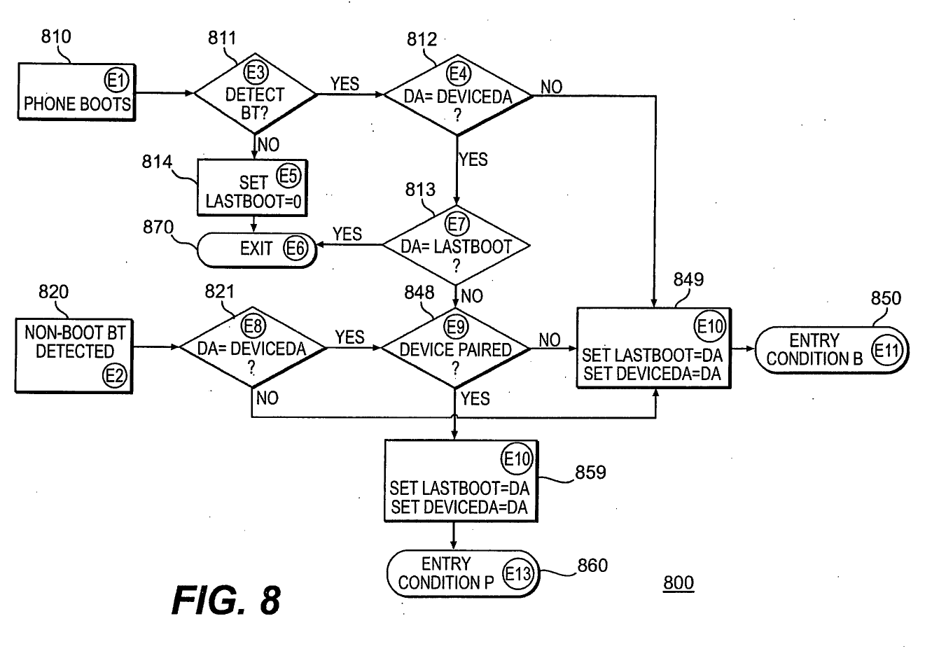

Referring to FIG. 7 which shows an exemplary pairing process 700, the Bluetooth adapter 500 will go into pairing/administration mode when it receives the Begin_Pair message from the phone 400 (705). Full use of a Bluetooth Enhanced Inquiry Scan and Interlaced Inquiry Scan (710) may be used to expedite a pairing process 700. A Bluetooth Limited Device Pairing procedure will be used to discover only Bluetooth devices that have the Headset profile. Referring to FIG. 7, the adapter 500 will place the associated radio into low power mode, e.g., no greater than 2 dBm during the exemplary pairing process 700. By reducing the power of the radio, the range will also be reduced and hence limit the likelihood of pairing with unwanted devices which happen to be in pairing mode at the same time. Once the adapter 500 enters Inquiry mode (725), the adapter 500 will remain in that mode for at least MinScan seconds (730). At the end of that time, the adapter 500 will report found devices (up to a maximum of 10) with the Device_Found message (735). The Device_Found message (737) will include the Device Address of the Bluetooth device as well as the User Friendly Name. If one (or more than one) Bluetooth device with the Headset Profile has been found, the adapter 500 will report the device(s) to the phone 400 in priority order (740). The adapter 500 will take advantage of RSSI with Inquiry results as part of the Bluetooth specification to determine which device has the strongest signal and will list devices from the strongest signal to the weakest.

If one or more device is found in which the signal strength is unknown, it (they) will be listed after those with known signal strength in the order of them being found. The phone will respond with a Bond, a Begin_Pair, or a Stop message. A Bond message refers to a Bond, e.g., the parameter entered with the Bond message that will be used for Bluetooth authentication as specified in the Bluetooth standard. If the passkey is accepted (750), a Result (Pass,DevAddr,LinkKey) message is sent to the phone (755). If the Passkey is rejected, a Result (Fail,DevAddr,LinkKey) message is sent to the phone.

Once the Begin_Pair message is received, the Bluetooth adapter will only remain in a Inquiry mode for MaxScan seconds. If no device is found in that time, the adapter will send a PR_Timeout message to the phone and leave Inquiry/pairing mode. Once pairing is complete, the phone will send the RF_Mode (DevAddr, LinkKey) message and the adapter will respond by going to full RF power mode and creating an ACL link with the device. If at anytime the adapter sees the RF_Mode (DevAddr, LinkKey) message, it will attempt to create a link using that link key with the device with that address.

FIG. 7 provides a high level flow of an exemplary pairing process 700 as it pertains to the phone 400 and adapter 500 interactions for developing a new pairing relationship. A previous pairing relationship can be re-established by the phone 400 by the RF_Mode (DevAddr, LinkKey) message as noted above. The Stop message is not explicitly shown in this flowchart since it can be sent by the phone at any time. If the adapter receives the Stop message it will terminate any pairing process. If pairing has not yet been completed, but a previous pairing had existed, the adapter 500 will restore all of the data associated with the previous pairing and maintain that link.

In an exemplary embodiment, only one wireless device is registered to the phone 400 at a time. Since only one device is registered to the phone 400 at a time, there is no need to continue to allow other devices to see the phone 400 or adapter 500. Thus, except for the time that the adapter 500 is in the pairing mode, the Bluetooth adapter 500 will not scan for, nor be able to be discovered by, another Bluetooth device in a preferred embodiment to provide additional security for the system. When handshaking with the wireless device, the Bluetooth adapter 500 will report the capability as supporting the Headset Profile. The adapter 500 will report support for all mandatory features required of an Audio Gateway (AG) supporting the Headset profile. The adapter 500 will also support optional features of an AG to support the features of the Bluetooth Handset. After a Bluetooth device is paired, the adapter 500 will attempt to establish a link with it. If the pairing process is successful, the adapter 500 will send the Link(1) message to the phone 400. If the link goes away for any reason, e.g., wireless device out of range or switched off, the adapter 500 will send the Link(0) message. The adapter 500 will then continually attempt to reestablish the link, and when the adapter does 500, the Link(1) message will be sent.

User Interface/Feature-Oriented Messages

A summary of illustrative messages and content capable of supporting the User Interface and specific features is provided hereinafter in TABLE IV. Exemplary messages, such as Off_Cradle, Low_Battery, Link_Query, etc, their related parameters, direction and a description of the related requirement are described in greater detail in TABLE IV.

| Message | Parameters | Direction | Requirement |
|---|---|---|---|
| BT_OFF_hk | none | To | When received from the phone, the adapter signals to |
| | | adapter | the Bluetooth device to go off-hook (create an SCO |
| | | | channel); it also switches the analog connection of |
| | | | the adapter so that the audio stream from the |
| | | | Bluetooth IC and associated A/D converter is passed |
| | | | through to the Audio Connection of the adapter. |
| BT_ON_hk | none | To | When received from the phone, the adapter signals to |
| | | adapter | the Bluetooth device to go on-hook (take down the |
| | | | SCO channel). |
| CC_Btn | none | To phone | When the adapter sees the Bluetooth message that |
| | | | the Call Control button has been pressed, it responds |
| | | | by sending the CC_Btn message to the phone. If |
| | | | there is no current Bluetooth call, the audio path |
| | | | between the Audio Connection and the Bluetooth |
| | | | A/D converter is created. |
| HdSet_OFF_hk | none | To | When received from the phone, the adapter switches |
| | | adapter | the audio path to the wired headset interface on the |
| | | | adapter. If there is an active SCO link with a |
| | | | Bluetooth device, an appropriate message will be |
| | | | sent to terminate the Bluetooth SCO session. |
| HdSet_off_hook_Req | none | To phone | When the adapter sees a Go Off-hook request on the |
| | | | Alternate Headset interface of the adapter, it will |
| | | | respond by doing the following: |
| | | | Send the HdSet_off_hook_Req message to the |
| | | | phone. |
| | | | Create an audio link (if one is not already |
| | | | present) between the Alternate Headset interface |
| | | | and the Audio Connection |
| | | | If there is an active SCO link with a Bluetooth |
| | | | device, it will send the appropriate Bluetooth |
| | | | message to terminate the SCO session |
| HdSet_on_hook_Req | none | To phone | When the adapter sees a Go On-hook request on the |
| | | | Alternate Headset interface of the adapter as |
| | | | specified in, it will respond by doing the following: |
| | | | Send the HdSet_on_hook_Req message to the |
| | | | phone. |
| ALERT_ON | none | To | When the adapter receives this message from the |
| | | Adapter | phone, it will send the Bluetooth RING message to |
| | | | initiate alerting in the device. It will repeat this |
| | | | message every 5.2 seconds until either: |
| | | | an ALERT_OFF message is received from the |
| | | | phone |
| | | | The BT_OFF_hk message is received from the |
| | | | phone |
| | | | the adapter receives a message from the |
| | | | Bluetooth device that the CC button has been |
| | | | pressed (+CKPD = 200) |
| | | | the link with the Bluetooth device is lost. |
| ALERT_OFF | none | To | When the adapter receives this message from the |
| | | Adapter | phone, if an SCO channel is not active (or not in the |
| | | | process of being set up1), it will release the |
| | | | RFCOMM link with the Bluetooth device and go to |
| | | | low power mode. If an SCO channel is active (or in |
| | | | the process of being set up1), it will ignore the |
| | | | ALERT_OFF message. |
| | | | Footnote 1: As a result of either a BT_OFF_hk |
| | | | message from the phone or a Bluetooth message |
| | | | (+CKPD = 200) from the Bluetooth device to indicate |
| | | | that the Call Control button has been pressed. |
| Off_Cradle | none | To phone | When the adapter sees a message which is an |
| | | | extension to the Headset profile that indicates that |
| | | | the Bluetooth handset has been removed from its |
| | | | cradle, it will send the Off_Cradle message to the |
| | | | phone. |
| Low_Battery | none | To phone | When the adapter sees a message which is an |
| | | | extension to the Headset profile that indicates that |
| | | | the Bluetooth handset is starting to be low (i.e., the |
| | | | Advanced Low-Battery condition), it will send the |
| | | | Low_Battery message to the phone. |
| Link | 0 or 1 | To Phone | When the adapter first detects that Bluetooth |
| | | | signaling link with the paired device has been |
| | | | established a Link(1) message is sent to the phone; if |
| | | | the link is lost, a Link(0) message is sent. |
| Link_Query | | To | When the adapter sees this message from the phone, |
| | | Adapter | it will respond with a Link(1) or Link(0) message to |
| | | | reflect whether there is an active signaling link for |
| | | | Bluetooth |

Response Times

The exemplary adapter 500 is particularly advantageous in that response times, e.g., for pairing with a Bluetooth handset, are optimized by limiting the adapter 500 to an operational link with one accessory at a time. For example, illustrative response times for the adapter 500 operating with a Bluetooth handset 600 are shown in greater detail in TABLE V.

TABLE V
Bluetooth response times

| | | |
|---|---|---|
| Maximum time during Pairing to discover the handset. Note, this | 5 | seconds |
| assumes the following: | | |
| timing begins once both devices are set to the proper pairing | | |
| mode | | |
| the MinScan parameter is set to this value to stop the | | |
| scanning process and report the results to the phone | | |
| no conflicts with other Bluetooth devices | | |
| Maximum time to initiate alerting in the handset after receiving | 500 | ms |
| ALERT_ON message from phone | | |
| Maximum time to terminate alerting in the handset after receiving | 500 | ms |
| ALERT_OFF message from phone | | |
| Maximum tune to send an Off_Cradle message to the phone after | 500 | ms |
| the handset is lifted from its cradle | | |
| Maximum time to establish an active SCO link as well as an | 750 | ms |
| analog path to the headset interface of the phone after: | | |
| Receiving BT_OFF_hk from phone | | |
| Call Control button on the handset button is pressed | | |
| Maximum time to take down an active SCO link after: | 750 | ms |
| Receiving BT_ON_hk from phone | | |
| Call Control button on the handset button has registered as | | |
| being pressed (i.e after the safety time to prevent an | | |
| inadvertent disconnect) | | |
| Maximum time to re-establish an SCO link after the loss of the | 5 | seconds |
| Bluetooth link while on an active call and the handset is brought | | |
| back within its 10 meter range | | |

In addition, analog response times for the adapter 500 for pairing with a headset 760 are also improved by one or more of the foregoing implementations. For example, TABLE VI includes representative response times for the adapter 500 when working with an analog device, such as the headset 760.

TABLE VI

| | |
|---|---|
| Maximum amount of time after receiving a Go Off-hook | 500 ms |
| request from a wired headset over the Alternate Headset | |
| Interface before the Headset_off_hook_Req message to the | |
| phone over the adapter interface is sent and the analog path | |
| to the Audio Connection is established. | |
| Maximum amount of time after receiving a Go On-hook | 500 ms |
| request from a wired headset over the Alternate Headset | |
| Interface before the Headset_on_hook_Req message is sent | |
| to the phone over the adapter interface. | |
| Maximum amount of time after receiving a HdSet_OFF_hk | 500 ms |
| command from the phone over the adapter interface before | |
| an analog path is established between the Audio | |
| Connection and the Alternate Headset Interface is | |
| established. | |

The Bluetooth handset 600 will go into pairing/administration mode when the handset 600 is idle AND the Call Control button 680 is pressed for 3 seconds, continuously. The user interface that is to be provided once pairing mode is entered is as follows. The alerter will emit a confirmation tone. As long as the device is in Pairing mode, the Bluetooth LED 660 will flash at a rate of 500 ms on and 500 ms off. Full use of the Bluetooth v1.2 Enhanced Inquiry Scan and Interlaced Inquiry Scan will be used to expedite the pairing process 700. The handset 600 will support the RSSI with Inquiry results capability as specified in v1.2 of the Bluetooth specifications.

When pairing is successfully completed with the reception of a Passkey from the Audio Gateway, and a link with the Audio Gateway has been established, the Bluetooth LED will turn steady Blue for 5 seconds and then revert to the status as indicated in FIG. 7. If a timeout occurs during the pairing process, the handset will emit via the alerter an error beep turn off the LED and leave pairing mode. Once the user indicates a desire to attempt to pair with another device, the handset will only remain in a limited discoverable mode (TGAP(104)) for a maximum of 60 seconds.

All settings and parameters that are impacted by pairing may be stored in non-volatile memory and will be preserved even in the event that the batteries lose power or are removed. If the pairing process 700 is terminated for any reason prior to completion (e.g., timeout of the TGAP(104) timer), any information pertaining to a previous pairing (if present) will be restored.

Link Establishment/Re-establishment and LED display. After pairing is complete, the handset will wait for the AG to attempt to establish a link with it. If the link is ever dropped, it will be the responsibility of the AG to re-establish the connection.

Battery States

One or more battery states may be indicated through a user interface provided on the display 200 and through various audio and/or visual signals from the handset 600. For example, during battery charging of the handset 600, the Bluetooth LED 660 will illuminate with a steady blue whenever the handset 600 is making appropriate contact with the charging cradle and charging power is available. If the handset 600 is alerting the user, such as while the phone 400 is being used to locate the handset 600, the Bluetooth LED may not illuminate with a steady blue. During an Advanced Low-Battery indication, the battery of the handset 600, such as when the handset 600 has approximately one hour of talk time remaining, will use a signal that is an extension to the Headset Profile to inform the adapter 500 of this condition. The message will only be sent once when this condition is first recognized. It will not be repeated unless the battery has been sufficiently charged to have more than 1 hour of talk time and then reaches the one-hour threshold again. There will be no change to the user interface of the handset when this event occurs. During a Low Battery condition, e.g., when the battery has approximately 15 minutes of talk-time remaining, the handset will begin emitting an error beep from the alerter 670. The error beep may be played every 60 seconds when the phone is idle and 120 seconds while it is active. If this tone is scheduled to sound during an alerting state, the Alert audio signal will temporarily cause the low battery audible alert to be suspended. Once the alerting state has completed, the low battery indication will resume after 60 seconds and thereafter at 60 or 120-second intervals depending upon the state of the handset as specified above. When the battery is low, the handset will flash the CC LED at a rate of 100 ms on and 2 seconds off. The exception to this is during alerting at which time the CC LED will flash at a selected rate.

Call States

The handset 600 may also be used to provide audio and/or visual indications of various call states. The use of the handset 600 to indicate call states may be limited to off-cradle conditions. For example, during an Idle Condition—off cradle, e.g., when the handset is off the cradle, has an established link, is in an idle condition, e.g., no active call or alerting, and the battery is not low, the Bluetooth LED will flash at a rate of 100 ms on and 5 seconds off. The CC LED 680 will be off. If the above is true, with the exception that the battery is low, the Bluetooth LED 660 will continue and the CC LED 680 and audio indication 670 will also be provided. During an Alerting Condition, the handset will provide local audio alerting through the use of the alerter 670. When the handset 600 receives an ALERT command, the Bluetooth LED will flash at a rate of 500 ms on and 500 ms off. In addition, if the handset 600 is off the cradle, the CC LED 680 will flash at a rate of 500 ms on and 500 ms off and will be synchronized with the Bluetooth LED 660. The audio response for this condition will depend upon whether the handset 600 is on the cradle or not at the time that the ALERT message was received. If it was on the charging cradle, no audible alerting will be provided. If it is off the cradle, alerting will be provided at a rate of 1.2 seconds on followed by 4 seconds off. The audible and visual alerting will continue until either the user answers the call by pressing the Call Control button 680, a BT command is received from the Audio Gateway to stop alerting, or until the link is lost.

During an active call condition, e.g., when on an active call involving the Bluetooth handset 600, as defined by any time there is an active SCO link, the Bluetooth LED 660 will flash at a duty rate of 100 msec on and 5 seconds off. If the battery is not low, the CC LED 680 will be on steady. When answering an alerting call, e.g., when the handset 600 is in the alerting mode, the call can be answered in one of two ways. First, if the handset 600 is on the cradle and in the alerting state and then detects the loss of contact with the charging contacts of the cradle, the handset will automatically send the appropriate button press command to the adapter 500. If the handset 600 is not in the cradle and is in the alerting state, and the Call Control button 680 is pressed, the handset 600 will send the appropriate button press command to the adapter 500.

When initiating an audio connection from the handset 600, the handset 600 can be used to initiate the creation of an audio (SCO) link to the phone 400 in three ways. For example, if the handset 600 is on the charging cradle and NOT in the alerting state, and the phone 400 detects that the handset 600 is removed from the cradle it will send a message to that effect to the phone 400. This message will be an extension to the Headset Profile. The phone 400 will, depending upon its state, respond with a message to set up a SCO link with the handset (see note) 600. If the handset 600 is on the charging cradle AND in the alerting state, and the phone 400, through the cradle, detects that the handset 600 is removed from the cradle, the phone 400 will send a standard Bluetooth message as if the CC Button 680 had been pressed. If the handset 600 is off the cradle and the Call Control button 680 is pressed, the handset 600 will initiate an Audio Connection Transfer towards the AG. The removal from cradle message may have two different responses from the phone 400, e.g., based on the call-state of the phone 400. Specifically, if the phone 400 is on an active call, the phone 400 will signal to the adapter 500 to initiate an SCO link with the handset 600 and perform an Audio Connection Transfer toward the HF. If the phone 400 is idle, no action will be initiated to cause the handset 600 to go off-hook.

In order to disconnect or terminate a call, e.g., while on an active call (as defined by an active SCO channel), the user will be able to terminate the call by pressing and holding the Call Control button 680 for 500 msec. When this is done, a disconnect message is sent to the adapter 500, a confirmation tone will be played over the alerter of the handset and the LEDs will revert to that. Alternatively, if the handset 600 is on an active call and phone 400 detects that it has been placed back on the charging cradle, it will immediately send the disconnect message and restore all LEDs to their appropriate idle-on-cradle state. No Confirmation tone will be played in this event. If the handset 600 is alerting while off the cradle and then detects being placed on the cradle, no Bluetooth message will be sent and the handset 600 will revert to the on-cradle-alerting. When this occurs, the local alerting being provided by the Bluetooth handset 600 will cease. If the handset receives a Bluetooth message from the phone 400 that indicates that the SCO link has been dropped, it will play a Disconnect tone over the alerter 670, return to Idle (and stop providing sidetone).

The 500 ms threshold is provided to prevent unwanted disconnects by inadvertently pressing the Call Control button 680 while just handling the handset 600. If a link is lost and needs to be re-established, e.g., when the phone is idle and on the cradle, a single error beep will be played over the alerter of the handset 600. In all cases in which the link is lost while off the cradle, the Bluetooth LED 660 will be extinguished. If the link is lost while off the cradle and the battery is not low, the alerter 670 will emit a single error beep. In the case of momentary loss and regain of link, the LED 660 will reflect the current status (link/no-link). However, if the link is restored for less than 5 seconds and then lost again, the error beep will not be re-played to indicate the subsequent loss of link. If the link is lost while off the cradle and the battery is low, the alerter will emit a single error beep and flash the CC LED red at a duty cycle. If the link is restored for less than 5 seconds and then lost again, the LED will again be turned off, but the error beep will not be played. If the link is lost while on an active call, e.g., an SCO channel is established, the handset 600 will stop providing sidetone, turn off the Bluetooth LED 660, and emit an Error Beep on the alerter 670. If the link is lost while the handset 600 is alerting, it should stop the alerter 670 and return to the idle mode. If the link is restored while on an active call, the handset 600 will re-instate sidetone, emit a confirmation tone on the alerter 670, and restore the Bluetooth LED 660 to its appropriate state for an active call. If the link is restored while the handset 600 is idle, the handset 600 will emit a confirmation tone on the alerter 670, restore the Bluetooth LED 660 to its appropriate state for an idle call. The detection of loss of link will be done in a manner that is standard within the Bluetooth profiles such that when the handset 600 works with any AG that also supports the Headset profile, both devices will be able to detect the loss of link.

Handset Finder

An optional function of the Phone/Bluetooth Adapter/Handset that may be supported is a Handset Finder/Locator feature. The phone 400 and adapter 500 will implement this capability by emulating the normal alert process for an incoming call. Hence, no additional messages or intelligence is needed in the handset to implement this feature.

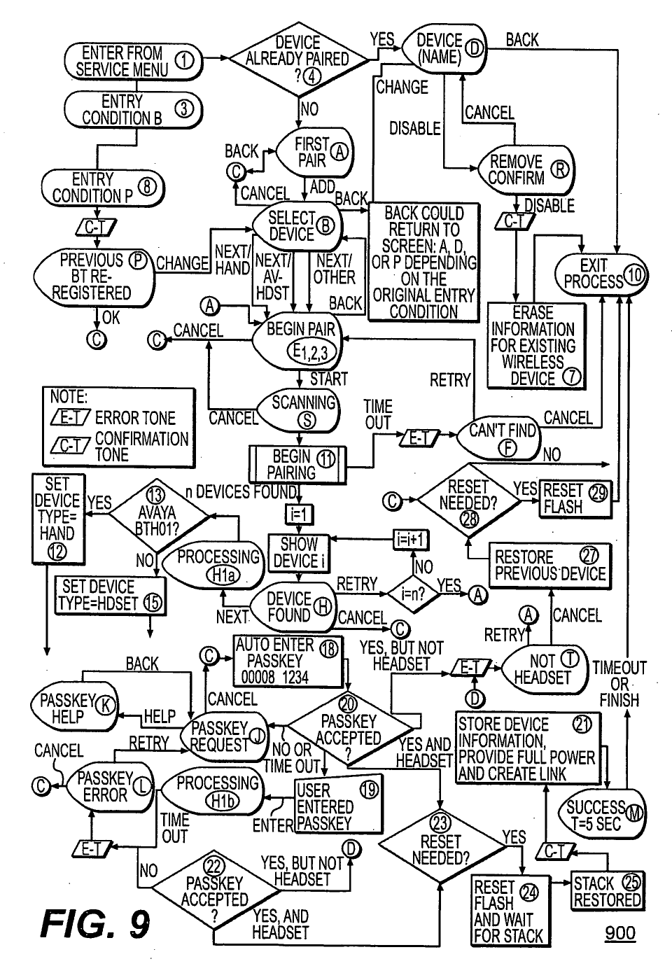

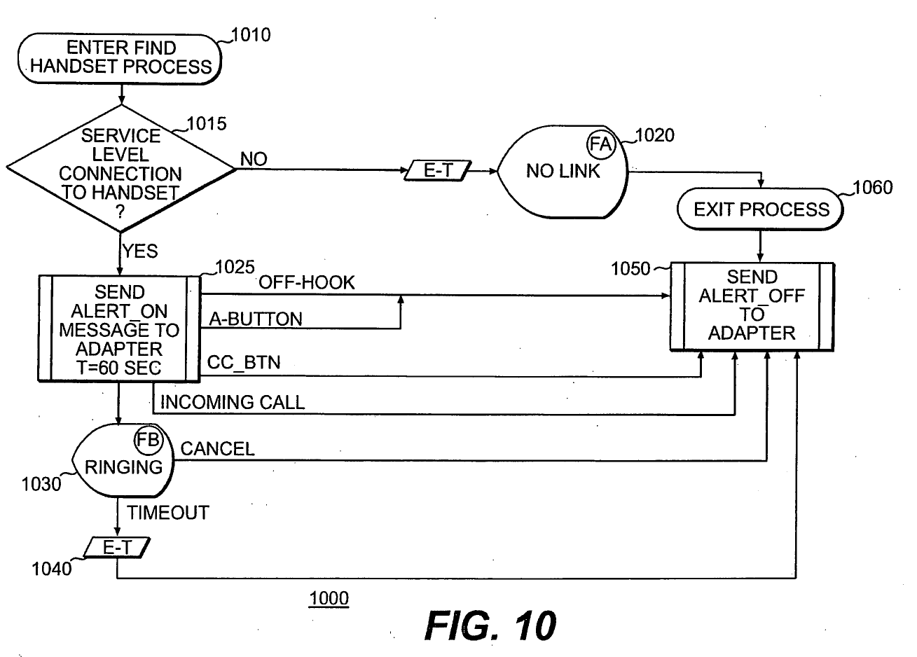

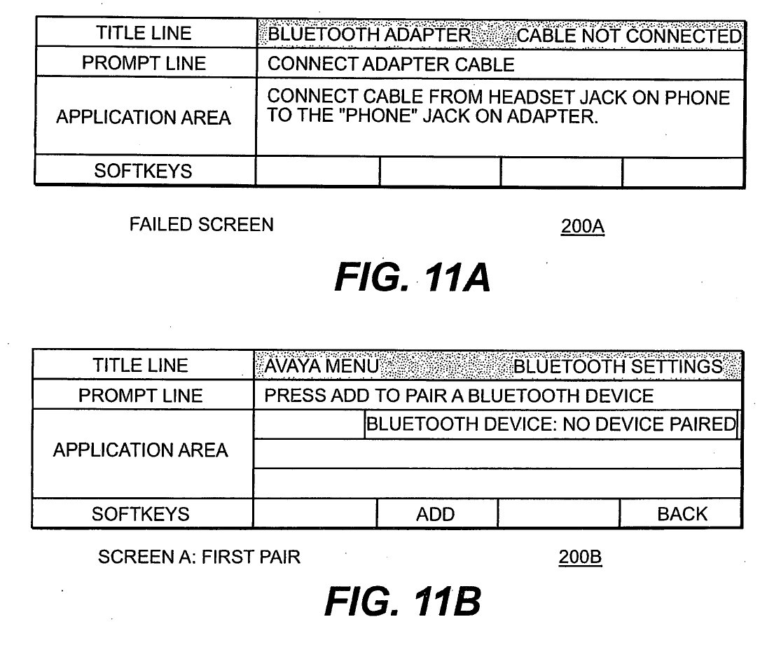

One or more of the foregoing implementations may include one or more of the following features and functionality incorporated into the handset 600, adapter 500, and/or phone 400. For example, FIG. 8 is a flowchart of an exemplary process for determining adapter condition for pairing with the wireless modular adapter and telephone base station. FIG. 9 is a flowchart of an exemplary process for administering and/or pairing a Bluetooth Adapter with a telephone base station. FIG. 10 is a flowchart of an exemplary process for a handset locator/finder feature for a system including a telephone base station and a wireless handset as shown in FIGS. 6A-6B.

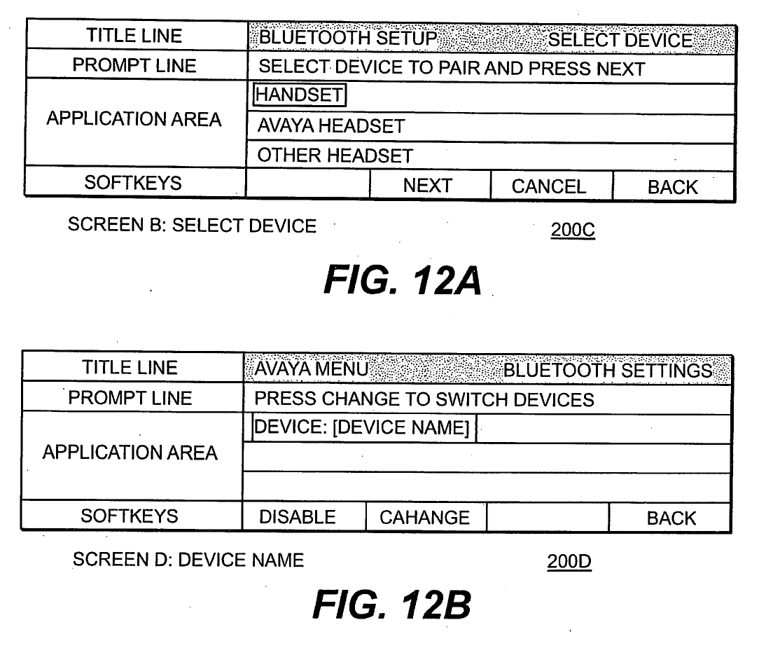

Referring to FIG. 8, a process 800 for determining adapter condition for pairing with the wireless modular adapter 600 and telephone base station 400 includes the following exemplary process steps. FIG. 8 outlines exemplary logic involved with determining at which point the process shown in FIG. 9 is described. Process 800 deals with the automatic entry of the pairing process when a Bluetooth adapter 500 is recognized either upon phone 400 boot-up or if an adapter 500 is inserted while the phone 400 is operational. FIG. 9 details the actual pairing and/or administration process 900 for Bluetooth devices. Below are descriptions of process and decision shapes associated with the flowcharts. Information for exemplary screen displays associated with processes 800, 900 are further described in connection with FIGS. 11A-15C.

Referring to FIG. 8, the phone 400 has just completed a boot process (810, E1). In step 811, E3, the phone 400 checks to see if a Bluetooth adapter 500 is detected. If no Bluetooth adapter 500 was detected, a parameter (LastBoot) is set to zero to indicate that the last time the phone booted (814, E5). If an adapter 500 is detected in step 811, E3, the Bluetooth Device Address (BDA) of the detected device is compared to determine if the BDA equals the Bluetooth Device Address (BDA) on record for a previously registered Bluetooth adapter 500 (812, E4). If not, the process proceeds to step 849, E10 and step 850, E11. In step 849, E10, the LastBoot and DeviceAddr are set to equal the Bluetooth Device Address (BDA) of the Bluetooth adapter that is being registered. In step 850, E11, the process continues to step 8 shown in FIG. 9. If the BDAs are not equal, the process 800 proceeds to step 813, E7. In step 813, the phone 400 checks to see if the Bluetooth Device Address of the Bluetooth adapter 500 being registered is the same as stored for the parameter LastBoot. If it is, it implies that the adapter 500 was present the last time the phone 400 booted and hence there is no need to bother the user with administration options (870, Exit). If not, the process continues to step 848, E9, where it is determined if the phone 400 is already paired with the device. If the phone 400 is already paired with the device, the process proceeds to step 859, E12. In step 859, E12, the LastBoot and DeviceAddr are set to equal the Bluetooth Device Address (BDA) of the Bluetooth adapter 500 that is being registered (860) and the process proceeds to step 860, e.g., step 8 in process 900.

In step 820, E2, a Bluetooth adapter 500 is detected at a time not associated with a phone boot process, e.g., if the adapter 500 is plugged in while the phone 400 is operational. In step 821, E8, the Bluetooth Device Address of the detected device is checked to see if it equals the Bluetooth Device Address on record for a previously registered Bluetooth adapter 500 and proceeds to either of steps 848, E9, or 849, E10 described above.

Referring to FIG. 9, various entry conditions are shown which interrelate with the process 800 of FIG. 8. For example, steps 1-29 are described in greater detail in TABLE VII.

TABLE VII

| | |
|---|---|
| 1 | Process starts here if it is entered via the Advanced Options Menu (see |
| | 9xxxLA.7.2.1300 |
| | [8.1-16]). |
| 3 | Process starts here if it is entered if the conditions for Entry Condition B are |
| | met in the first flow chart. |
| 4 | If a device has already been paired when the process is entered from the |
| | Advanced Options Menu, the option is given to administer the existing |
| | paired device; if no device is already registered, it is assumed that the user |
| | wants to begin the pairing process. |
| 7 | If user selects the “Disable” option, existing pairing information will be |
| | erased. |
| 8 | Process starts here if it is entered if the conditions for Entry Condition P are |
| | met in the first flow chart. |
| 10 | This is the exit point for the administration/pairing process. Upon exiting, |
| | the phone will be restored to the state it was in when pairing/administration |
| | was started. So, for example, if pairing was started as a result of entering |
| | via the Service Menu, when it is completed, the user will be returned to the |
| | Service Menu - Advanced Options. Likewise, if the process is initiated as a |
| | result of detecting a Bluetooth adapter, when the pairing process is |
| | completed, it will return the phone to the state that it would have entered if |
| | the Bluetooth adapter had not been detected at that time. |
| 11 | The phone sends a Begin Pair command to the adapter. The adapter will go |
| MR | into Inquiry mode and report back to the phone a prioritized list of devices |
| 56426 | found. The priority will be based on Received Signal Strength Indicator |
| approved | (RSSI) with strongest signal being first. (See 9xxxBTA.3.3.200 [8.1-20]) |
| | The phone will wait until the Bluetooth stack is idle (i.e., any previously |
| | active ACL or SCO links properly taken down), before sending the Begin |
| | Pair message to the adapter. |
| Note: | This prevents problems which could exist if the user were to try to rapidly |
| | go through the pairing menus and begin pairing before all of the links and |
| | data associated with a previous pairing have had a chance to be taken down, |
| | which, if the only existing link were an ACL link could take 11 seconds; an |
| | ACL plus a SCO link could take as much as 20 seconds. |
| 12 | The Device Type is set to Hand to indicate that it is a handset. This will be |
| | used in the Section 3.4 to determine how specific events are to be handled. |
| 13 | The User Friendly Name, as reported to the phone by the adapter as part of |
| | the Device Found command is checked to see if it is of the form: Avaya |
| | BTHxx (where xx is any integer from 01 to 99). If it is, it will be treated as |
| | a handset; if the name does not fit this description, it will be treated as a |
| | headset. |
| Note: | As of S1.2 only one handset type is recognized and therefore the “xx” |
| | designation will not have an impact on how the device is handled. It is |
| | provided as a placeholder should subsequent Bluetooth handsets be developed |
| | which warrant special treatment by software. |
| 14 | If multiple devices are found with these profiles, an Error Tone is played |
| | and an error message is displayed as depicted in Screen G. |
| 15 | Set Device Type to HdSet. This will be used in the Section 3.4 to determine |
| | how specific events are to be handled. |
| 18 | When prompted by the adapter for a PassKey (Device _Found), the phone |
| | will automatically respond by sending the Bond message - with a Passkey |
| | of 0000 (four zeroes). A 10 second timer is started in case a problem occurs |
| | with the exchange of PassKey information. |
| Rationale: | Many Bluetooth headsets have a simple Passkey of “0000” which cannot |
| | be changed and hence affords limited security. Instead, security is provided |
| | by the fact that: |
| | manual intervention is required at both devices before pairing can be initiated |
| | pairing can only be accomplished during a short timeframe |
| | when pairing is done, the power setting is set low to minimize the effective |
| | radius of devices that can “see” the adapter |
| | manual confirmation is required |
| | Only a single device can be paired at one time |
| | Because of this, the extra step of requiring the user to enter “0000” |
| | is avoided by having the adapter automatically try this Passkey first, |
| | without requiring the user to enter it. This can avoid considerable |
| | frustration if the user has forgotten the Passkey or misplaced the manual |
| | that came with the headset. |
| 19 | User enters the Passkey manually as requested in Screen J and presses |
| | Enter. A 10 second timer is started in case a problem occurs with the |
| | exchange of PassKey information. |
| 20 | The adapter will inform the phone if the Passkey was accepted |
| | [Result(Pass.DevAddr, LinkKey)]. If the correct Passkey is either |
| | automatically entered by the phone or manually entered by the user, a |
| | confirmation in the form of a confirmation tone and screen will be provided. |
| 21 | All parameters associated with the Bluetooth device are stored in non- |
| | volatile memory, the phone tells the adapter to go to full radio power - |
| | RF_Mode(DevAddr.LinkKey), which also grants permission to create a |
| | permanent data link to the Bluetooth device. |
| | Any parameters associated with devices which have previously been paired |
| | will be over-written at this point. |
| 22 | If the Passkey is accepted by the device, a confirmation tone is played, and |
| | control passed to Shape 21. If the Passkey is not accepted, an error tone is |
| | played and then Screen L displayed. |
| 23 | Check if the adapter indicates that it needs to be reset because of |
| | approaching the threshold of the Flash memory. |
| 24 | Issue command to reset the flash and wait for completion |
| | Note: While the stack is resetting, the user will continue to see Screen H1a/b |
| | and hence the reset will be essentially transparent to the user since it will |
| | only add approximately an additional second to the Passkey verification process. |
| 25 | When the stack is restored, continue |
| 27 | Reject device that does not support headset profile and restore bonding |
| | information for previously paired device (if any). |
| 28 | Check if the adapter indicates that it needs to be reset because of |
| | approaching the threshold of the Flash memory. |
| 29 | Issue command to reset the flash |

Referring to FIG. 10, a process 1000 for finding a handset includes one or more of the following process steps. In step 1010, the phone 400 determines the service level connection to the handset 600. If the handset 600 is not connected, no link is detected (1020) and the process is exited (1060). If the handset connection is detected at step 1010, an Alert_On message is sent to the adapter 500, e.g., with a time of 60 seconds (1025). The handset 600 will continue ringing (1030) until the process times out (1040), or one or more conditions are satisfied that will result in an Alert_Off signal being sent to the adapter 500 (1050). For example, the CC button 680 may be pushed, an incoming call may interrupt the find process, and/or the phone 400 may be in an Off-hook mode, e.g., speakerphone activated at the phone 400.

Referring to FIGS. 11A-15C, throughout one or more of the processes 800, 900, 1000 described above, one or more of the following exemplary screens 200A-200K may be displayed on the user interface, e.g., the display 200 of the phone 400, to indicate and/or control operational states of the phone or one or more accessories. FIG. 11A is an exemplary screenshot 200a of a user interface 200 indicating an operational state of the wireless modular adapter 500. When a Bluetooth adapter is installed and an audio connectivity check is performed, during the time from the sending the Audio_Chk command until either the Go Onhook command is received or until the 500 ms timer has elapsed, any requests coming over the adapter interface that would involve setting up an audio link over the headset interface will be buffered. In this event, if the connectivity test passes, e.g., the Go Onhook command received, the request will be carried out in a normal manner. However, if the connectivity test fails, the request for an audio path will be ignored and the Connectivity Failed interrupt screen 200a will be shown until repeated tests as specified above indicate a successful connection of the audio cable or until the Bluetooth adapter is removed.

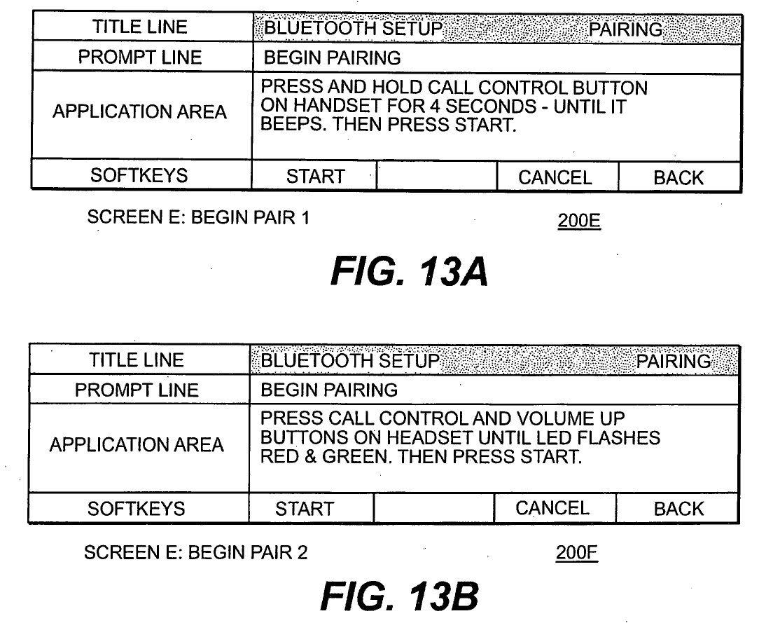

FIG. 11B is an exemplary screenshot 200b of a user interface 200 initiating a pairing process 800, 900 and indicating the status of any detected wireless devices. This screen is first displayed when a Bluetooth device has not yet been paired and after entering from the Advanced Options Menu or when a Bluetooth adapter 500 is recognized as defined by the process shown in process 800. FIG. 12A is an exemplary screenshot 200c of a user interface 200 prompting a user to select a device for a pairing process 800, 900. This screen is displayed just prior to the beginning of the pairing process. Pressing “Back” will cause a return to the most recently displayed screen, which, because there are so many ways to get to this screen, the paths for “Back” are not shown on the flow chart. If Next is pressed, the highlighted option will be selected. For phones that have application line buttons, pressing an application button next to a line which has a valid option will be treated the same as if the line was first highlighted and then Next pressed. FIG. 12B is an exemplary screenshot 200d of a user interface 200 prompting a user to designate or select a device name for a subsequent pairing process 800, 900. This screen is displayed when the device is already paired. The device name (without the brackets) will be the User Friendly Name of the device as passed from the adapter to the phone. While the complete name may be up to 248 bytes long (see Note for Screen H), it is acceptable to display only the left-most characters up to the limit for the line. The first line in the Application area will be formatted such that only a single space exists between the device name and the word “Device”. Pressing Remove causes Screen R to be shown; Change goes to Screen B and Back causes an exit from the process 900 (step 10).

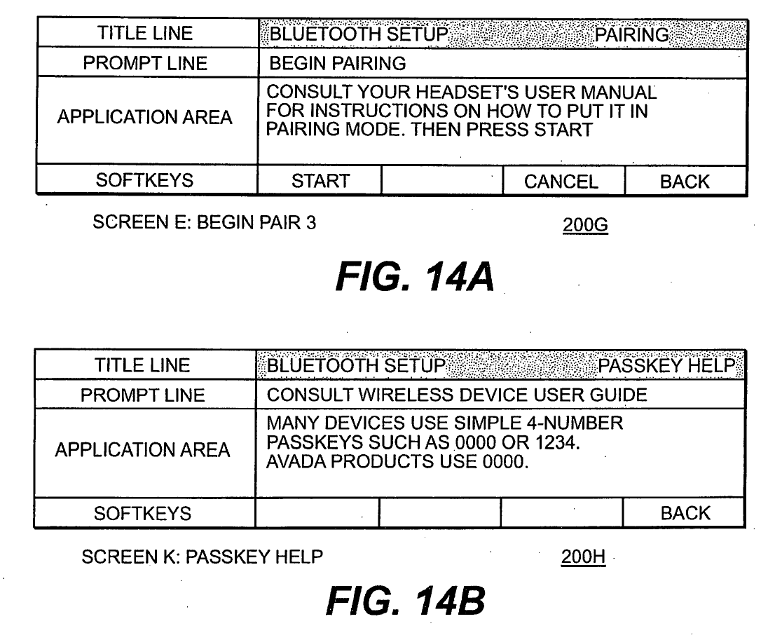

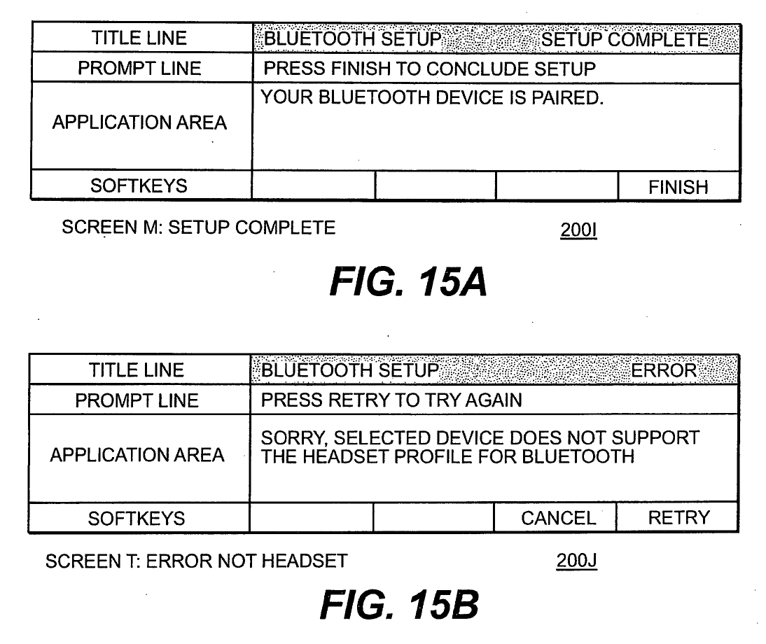

FIG. 13A is an exemplary screenshot 200e of a user interface prompting a user to initiate a step within a pairing process for a first device. This screen is displayed prior to the adapter entering pairing mode and is shown after the user indicates a desire to pair with a handset (due to user selection in Screen B). FIG. 13B is an exemplary screenshot 200f of a user interface 200 prompting a user to initiate a step within a pairing process 800, 900 for a second device. This screen is displayed prior to the adapter entering pairing mode and is shown after the user indicates a desire to pair with an Avaya headset (due to user selection in Screen B). FIG. 14A is an exemplary screenshot 200g of a user interface 200 prompting a user to initiate a step within a pairing process 800, 900 for an unregistered or unrecognized device. For example, this screen is displayed prior to the adapter entering pairing mode and is shown after the user indicates a desire to pair with a third party headset (due to user selection in Screen B). FIG. 14B is an exemplary screenshot 200h of a user interface 200 prompting a user to enter or designate a passkey or other unique identifier. This screen is displayed if the user presses “Help” while being prompted for a passkey.

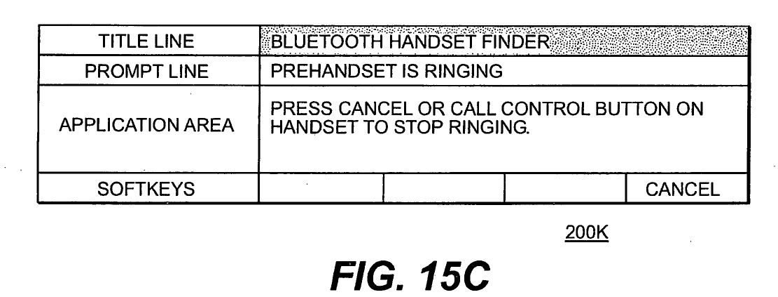

FIG. 15A is an exemplary screenshot 200i of a user interface 200 notifying a user that the pairing process for a device has been completed. This screen is displayed once the Passkey is accepted and pairing is finished. It is accompanied by the confirmation tone (See AUDIO.210.100 [8.1-3]). It will display for 5 seconds (or until Finish is pressed) before the pairing process is exited. Note, this screen may be removed as a result of another application. If it is, it will successfully terminate the BT application as if the “Next” key were pressed. FIG. 15B is an exemplary screenshot 200j of a user interface 200 notifying a user of an error within the pairing process for a device. This screen is shown if the paired device does not support the Headset Profile. It is accompanied by the error tone. FIG. 15C is an exemplary screenshot 200k of a user interface 200 notifying a user of the activation of the handset finder function. Upon entering the Finder process 1000, the phone 400 first checks to see if the handset 600 and phone 400 have an active link established by checking the state of the Link(x) parameter. If a link is not established, the screen below is displayed, giving the user the option to exit the Finder function by choosing “Cancel”. If Cancel is chosen, the phone will return to the idle state. This screen will timeout after 5 seconds.

While the foregoing implementations have been described in connection with a deskphone 100, any telephony device supporting circuit switching, packet switching, and/or other telephony networking may benefit from the implementations. Accordingly, the foregoing implementations are equally applicable to PDAs, VoIP phones, and/or mobile phones. An exemplary telephony device that may incorporate one or more of the foregoing implementations includes any of the Avaya ONE-X deskphones, such as the Avaya ONE-X 9600 and 9650 series.

The telephony device, e.g., deskphone 100 shown and described in connection with FIG. 1, may include a processor, a memory, the display 200, and an input/output interface. In addition, the phone, e.g., if used in a network, may include a network interface for sending and receiving data over a network connection, e.g., such as a standard RJ-45 Ethernet connection. The processor may include one or more processors for controlling, interpreting, and/or processing data exchanged between the telephony device and the network. The memory may be one or more memory devices or media capable of storing data or instructions. In addition, or alternatively, the telephony device may include an integrated processing device or module, e.g., an analog telephony adapter (ATA) and/or combination of client software residing in memory. The ATA and/or client software may utilize audio codecs to handle data packet conversion, e.g., digital-to-analog conversion of incoming voice data. One or more telecommunications protocols, such as, for example, H.323, may be used to define ways in which video, audio, and/or data is processed and/or transferred through the network which the telephony device is connected.

The preprogramming of the auxiliary softkey labels 240, 250 and/or softkey labels 230 into the telephony device can be achieved in several ways, e.g., to control various Bluetooth functions and controls shown in the user interface screenshots 200a-200k. For example, a system administrator, manufacturer, and/or user may update settings or functions, e.g., control which auxiliary softkey labels are displayed, through periodic updates, e.g., network patches sent to individual client devices to implement global and/or local updates to software resident in the memory of the telephony device. Alternatively, or additionally, the adjustment of softkey label settings may be implemented through a settings menu within the individual client device, e.g., through the menu option button 372. Exemplary methods of administering and/or programming an applicable telephony device are described in greater detail in Avaya one-X Deskphone Edition for 9600 Series IP Telephones Administrator Guide Release 1.2, Doc. No. 16-300698, e.g., available at http://support.avaya.com, the entire contents of which are hereby incorporated by reference.

Although some cell phones incorporate illuminated keys beneath a display, one implementation applied to mobile telephony devices, such as cell phones or PDAs, would include selectively illuminating only certain keys (or softkeys if provided) to correspond to display items on the display of the cellular telephone. Cellular telephones also have numerous functional controls, perhaps more than desktop telephones, such as “airport mode,” “vibrate mode, “blue tooth,” etc. The selective illumination of keys provides the user with the ability to quickly evaluate the settings of such functions. For example, if three icons or labels were on the display screen at one time, the user would instantly know if the airport mode was on or off, if the vibration setting for incoming calls was on or off, and/or if the blue tooth transceiver was on or off, simply by viewing the key board, e.g., the illuminated or non-illuminated keys.

Accordingly, the key board would act as an extended display, which would free up the relatively small display of a cellular telephone to show larger icons, etc. Accordingly, standalone softkeys in a button array, or existing keys, such as alphanumeric keys in a phone keypad may be used to provide selective illumination corresponding to an icon or label array which is displayed on a display screen of any telephony device. The alphanumeric keys may be included in an ISO (International Standards Organization), alphanumeric keypad for telephony devices, e.g., for cellular phones, for PDAs, and/or for deskphones. For example, the keypad may be a standard ISO, alphanumeric keypad for a deskphone shown in FIG. 1. The user interface may include separate softkeys, integrate the functionality of the softkeys into the alphanumeric keypad, or any combination thereof.

The coordinated display of softkey labels and the control of the associated functions and options may be implemented through hardware, firmware, a software module executed by a processor within the telephony device, or in a combination of the two. A software module may reside in RAM memory, flash memory, ROM memory, EPROM memory, EEPROM memory, registers, hard disk, a removable disk, a CD-ROM, or any other form of storage medium known in the art and capable of residing within the telephony device or associated network. An exemplary storage medium is coupled to the processor such that the processor can read information from, and write information to, the storage medium. In the alternative, the storage medium may be integral to the processor.

Accordingly, one implementation can include a computer readable media embodying one or more of the processes or subprocesses described and shown in connection with FIGS. 5-15B of this description. The computer readable media may be resident in the client device, on a network, or in any combination thereof. Accordingly, the invention is not limited to illustrated examples and any device for performing the functionality described herein are included in embodiments of the invention.

Although detailed embodiments and implementations have been described above, it should be apparent that various modifications are possible without departing from the spirit and scope of the present invention.

What is claimed is:

1. A modular system for supporting wireless and wired telecommunication, comprising:
a telephone base station having a housing configured to operatively connect with one or more modular adapters, wherein the housing includes:
a display;
an alphanumeric keypad;
a wireless adapter interface; and
a headset interface; and
a wireless adapter module configured to operatively connect to the telephone base station through the wireless adapter interface;
a wireless handset, wherein the handset is configured to selectively communicate wirelessly with the telephone base station through an operative connection with the wireless adapter module and the wireless adapter module is configured to selectively communicate through a wired connection with the telephone base station.

2. The modular system according to claim 1, further comprising a headset configured to communicate with the telephone base station through a wired connection with the headset interface.

3. The modular system according to claim 2, wherein the wired connection with the headset interface is operatively connected to the wireless adapter module.

4. The modular system according to claim 3, further comprising a second wired connection for operatively connecting the headset to the wireless adapter module.

5. The modular system according to claim 3, wherein the headset is configured to communicate wirelessly with the wireless adapter module or through a wired connection with the wireless adapter module.

6. The modular system according to claim 1, wherein the wireless adapter module comprises a controller configured to transmit and receive radio signals according to a frequency hopping radio system.

7. The modular system according to claim 1, wherein the wireless adapter module is configured to support communication with the wireless handset based on a radio-frequency standard.

8. The modular system according to claim 7, wherein the radio-frequency standard includes BLUETOOTH protocol.

9. The modular system according to claim 1, wherein the housing further comprises:
a first housing which includes the display and the alphanumeric keypad; and
a second housing configured to operatively connect with the first housing, wherein the second housing includes the headset interface, the wireless adapter interface, and a wireless handset cradle.

10. The modular system according to claim 9, further comprising:
a third housing configured to operatively connect with the first housing instead of the second housing, wherein the third housing includes a handset cradle and a wired handset for operation of the system as a hard wired system.

11. The modular system according to claim 9, wherein the handset cradle comprises:
a recess contoured to integrally fit with an exterior surface of the wireless handset; and
a power interface configured to operatively connect with the wireless handset when the wireless handset is positioned within the recess and to charge the wireless handset.

12. The modular system according to claim 1, wherein the alphanumeric keypad is an ISO (International Standards Organization) standard alphanumeric telephony keypad.

13. A wireless adapter module for supporting wireless and wired telecommunication, comprising:
a wireless adapter interface configured to operatively connect to a telephone base station and to support wireless communication with a wireless handset; and
a headset interface configured to operatively connect to a headset to support communication with the telephone base station.

14. The wireless adapter module according to claim 13, wherein the wireless adapter interface is configured to operatively connect to the telephone base station through a port within a host telephone base station.

15. The wireless adapter module according to claim 13, wherein the wireless adapter interface is configured to operatively connect through a wireless connection with the telephone base station.

16. The wireless adapter module according to claim 14, wherein the wireless adapter module comprises a controller configured to transmit and receive radio signals with a wireless handset according to a frequency hopping radio system.

17. The wireless adapter module according to claim 14, wherein the wireless adapter module is configured to support communication with a wireless handset based on a radio-frequency standard.

18. The wireless adapter module to claim 17, wherein the radio-frequency standard includes BLUETOOTH protocol.

19. The wireless adapter module according to claim 13, wherein the wireless adapter module is a Bluetooth Class 2 device having a range of at least 10 meters.

20. The modular system according to claim 1, wherein the wireless adapter module is a Bluetooth Class 2 device having a range of at least 10 meters.

21. The wireless adapter module according to claim 19, wherein the wireless adapter module is configured to operatively connect to an adapter port of a Voice over Internet Protocol (VoIP) telephone base station.

22. The wireless adapter module according to claim 20, wherein the wireless adapter module is configured to operatively connect to an adapter port of the telephone base station, and the telephone base station is a Voice over Internet Protocol (VoIP) telephone base station.

23. A method for managing a wireless accessory with a telephone base station, comprising:
detecting one or more wireless accessories paired with the telephone base station;
identifying the one or more wireless accessories paired with the telephone base station;
determining an operational state of any wired accessories and any of the wireless accessories paired with the telephone base station;
providing a first user interface on a display of the telephone base station if a first wireless accessory is identified and determined to be in an active operational state which includes features for managing the first wireless accessory at the telephone base station; and
alternatively providing a second user interface on the display of the telephone base station if an alternative accessory is identified and determined to be in an active operational state which includes features for managing the alternative accessory at the telephone base station.

24. The method according to claim 23, wherein the first wireless accessory is a wireless headset or a wireless handset.

25. The method according to claim 24, wherein the alternative accessory is a wired accessory or a wireless accessory.

26. The method according to claim 25, wherein the first wireless accessory and the alternative accessory comprise a wireless handset and a headset, respectively.

27. The method according to claim 26, wherein the headset is a wired or wireless headset.

28. The method according to claim 27, wherein the wireless headset is a Bluetooth device and the headset is a Bluetooth device.

29. The method according to claim 27, wherein the wireless handset is a Bluetooth device and the headset is a wired headset.

30. The method according to claim 23, further comprising selectively controlling an operation of the first wireless accessory or the alternative accessory with a softkey or button on the telephone base station.

31. A computer-readable medium having computer-executable instructions contained therein for a method for managing a wireless accessory with a telephone base station, the method comprising:
detecting one or more wireless accessories paired with the telephone base station;
identifying the one or more wireless accessories paired with the telephone base station;
determining an operational state of any wired accessories and any of the wireless accessories paired with the telephone base station;
providing a first user interface on a display of the telephone base station if a first wireless accessory is identified and determined to be in an active operational state which includes features for managing the first wireless accessory at the telephone base station; and
alternatively providing a second user interface on the display of the telephone base station if an alternative accessory is identified and determined to be in an active operational state which includes features for managing the alternative accessory at the telephone base station.

32. A modular system for supporting wireless and wired telecommunication, comprising:
a telephone base station having a housing configured to operatively connect with one or more modular adapters, wherein the housing includes:
a display;
an alphanumeric keypad;
a wireless adapter interface;
a headset interface; and
a process controller; and
a wireless adapter module configured to operatively connect to the telephone base station through the wireless adapter interface;
a wireless handset, wherein the handset is configured to selectively communicate wirelessly with the telephone base station through an operative connection with the wireless adapter module or to selectively communicate through a wired connection with the telephone base station, wherein the process controller is configured to detect a power level of a wireless device in operative connection with the telephone base station, to detect and identify one or more wireless or wired accessories paired with the telephone base station, and to provide a unique user interface, associated with each identified wireless or wired accessory, to a user of the telephone base station.

33. A method of managing a wireless accessory operatively connected to the telephone base station of the system of claim 32, the method comprising:
receiving an indication of a power level of a wireless Bluetooth accessory paired with the telephone base station; and
providing a user with a visual or audio signal from the telephone base station that the wireless Bluetooth accessory is in a low power state.

34. The method according to claim 33, wherein providing the user with the visual signal comprises providing a user interface on a display of the telephone base station which prompts a user to charge the wireless Bluetooth accessory on a charging cradle of the telephone base station.

35. A method of managing a wireless handset associated with a IP telephone base station, the method comprising:
detecting an on-cradle or an off-cradle state for the wireless handset associated with the IP telephone base station;
providing a voice data path to the wireless handset if the wireless handset is in the off-cradle state; and
providing a voice date path which omits the wireless handset if the wireless handset is in the on-cradle state.

36. The method according to claim 35, further comprising:
detecting an operational state of a headset associated with the IP telephone base station; and
alternatively providing a voice date path to the headset associated with the IP telephone base station if the headset is in an active state.

37. The method according to claim 36, further comprising:
providing a first user interface on a display of the telephone base station if the wireless handset is detected in the off-cradle state, the user interface including features for managing the wireless handset at the telephone base station.

38. The method according to claim 37, further comprising:
if the headset is detected to be in an active operational state, alternatively providing a second user interface on the display of the telephone base station which includes features for managing the headset at the telephone base station.

39. The method according to claim 38, further comprising:
receiving an indication of a power level of the wireless handset paired with the telephone base station; and
providing a user with a visual or audio signal from the telephone base station that the wireless handset is in a low power state.

40. The method according to claim 39, further comprising providing a user interface on a display of the telephone base station which prompts a user to charge the wireless handset on a charging cradle of the telephone base station.

41. The method according to claim 40, wherein at least one of the wireless handset and the headset is a Bluetooth device.

42. A computer-readable medium having computer-executable instructions contained therein for a method of managing a wireless handset associated with a IP telephone base station, the method comprising:
detecting an on-cradle or an off-cradle state for the wireless handset associated with the IP telephone base station;
providing a voice data path to the wireless handset if the wireless handset is in the off-cradle state; and
providing a voice date path which omits the wireless handset if the wireless handset is in the on-cradle state.

43. The computer-readable medium according to claim 42, wherein the method further comprises:
detecting an operational state of a headset associated with the IP telephone base station;
alternatively providing a voice date path to the headset associated with the IP telephone base station if the headset is in an active state;
providing a first user interface on a display of the telephone base station if the wireless handset is detected in the off-cradle state, the user interface including features for managing the wireless handset at the telephone base station;
if the headset is detected to be in an active operational state, alternatively providing a second user interface on the display of the telephone base station which includes features for managing the headset at the telephone base station;
receiving an indication of a power level of the wireless handset paired with the telephone base station; and
providing a user with a visual or audio signal from the telephone base station that the wireless handset is in a low power state.

44. The computer readable medium according to claim 43, wherein the method further comprises providing a user interface on a display of the telephone base station which prompts a user to charge the wireless handset on a charging cradle of the telephone base station, and at least one of the wireless handset and the headset is a Bluetooth device.

45. A method for pairing a Bluetooth wireless adapter with a IP telephone base station, the method comprising:
determining if a Bluetooth wireless adapter is detected in operative connection with the IP telephone base station;
if the Bluetooth wireless adapter is detected, setting a parameter (LastBoot) to zero to indicate a most recent occurrence of the telephone base station being booted;
if the Bluetooth wireless adapter is detected, comparing a Bluetooth Device Address (BDA) of the detected adapter to a stored Bluetooth Device Address (BDA) for a previously registered Bluetooth wireless adapter; and
pairing a local wireless accessory to the IP telephone base station.

46. The method according to claim 45, wherein pairing the local wireless accessory comprises:
setting a radio power level of the Bluetooth wireless adapter to a relatively low level;
scanning for local wireless accessories in a vicinity of the Bluetooth wireless adapter;
registering a single, local wireless accessory in the vicinity of the Bluetooth wireless adapter; and
increasing the radio power level of the Bluetooth wireless adapter to a relatively higher level and discontinuing any scanning for additional wireless accessories in the vicinity of the Bluetooth wireless adapter.

47. The method according to claim 45, wherein pairing the local wireless accessory to the IP telephone base station comprises identifying if the local wireless accessory is at least one of a wireless handset or a wireless headset.

48. The method according to claim 46, further comprising toggling between operation in a headset mode and a wireless handset mode through a user interface provided on the telephone base station or wireless handset.
